(19) United States
(12) Patent Application Publication
(10) Pub. No.: US 2026/0088930 A1
(43) Pub. Date: Mar. 26, 2026

(54) EARLY EFFICIENT TERMINATION OF TRANSMISSION OF PDU SETS GENERATED BY AL-FEC IN A WIRELESS COMMUNICATION NETWORK

(71) Applicant: Lenovo (Singapore) Pte. Ltd., Singapore (SG)

(72) Inventors: Razvan-Andrei Stoica, Witten (DE); Prateek Basu Mallick, Dreieich (DE); Joachim Löhr, Wiesbaden (DE); Dimitrios Karampatsis, Ruislip (GB); Ravi Kuchibhotla, Chicago, IL (US)

(21) Appl. No.: 19/111,735

(22) PCT Filed: Oct. 24, 2022
(86) PCT No.: PCT/EP2022/079608

§ 371 Date: Mar. 13, 2025

(30) Foreign Application Priority Data
Sep. 14, 2022 (GR) 20220100751

(51) Int. Cl. H04L 1/00

(52) U.S. Cl. CPC H04L 1/0057

(57) ABSTRACT

There is provided a method in a node of a wireless communication network. The method comprises receiving from an application a protocol data unit (PDU) set corresponding to an encoded application data unit (ADU). The method further comprises determining an Application-Layer Forward Error Correction (AL-FEC) coding configuration associated with the encoded ADU and transmitting the PDU set. The method further comprises determining whether a cease criterion is satisfied, wherein the cease criterion is based on the AL-FEC coding configuration, and ceasing transmission of the PDU set based on the cease criterion being satisfied.

### FIELD

The subject matter disclosed herein relates generally to the field of implementing efficient transmission of PDU sets in a wireless communication network. This document defines a method in a node of a wireless communication network, a node in a wireless communications network, a method in a user equipment apparatus of a wireless communication network, and a user equipment apparatus for communicating with a wireless communication network.

### BACKGROUND

Herein, extended Reality (NR) is used as an umbrella term for different types of realities of which Virtual Reality, Augmented Reality, and Mixed Reality are examples. AR application traffic is subject to strict bandwidth and latency limitations in order to deliver an appropriate Quality of Service and Quality of Experience to an end user of an NR service. Such strict bandwidth and latency limitations can make delivery of XR application traffic over a wireless communication network challenging. IETF defined to this point a generic forward error correction framework (FECFRAME) as IETF RFC 6363 which allows for various FEC Schemes to be applied for application-level FEC. FECFRAME specifies source packet and repair packet formats and FEC Scheme configuration procedures for AL-FEC both over transport layer (e.g., UDP), as well as over RTP layer or alike (e.g., WebRTC). AL-FEC traffic comprises both source PDUs and repair PDUs.

### SUMMARY

In the context of NR media traffic, 3GPP SA2 Work Group recently introduced the concept of a ‘PDU set’ to group a series of PDUs carrying a unit of information at the application-level. When application-layer FEC is applied to a PDU set, it is possible that a situation will occur part way through transmission of a PDU set that renders the transmission of the rest of the PDUs of the PDU set redundant. Identifying such an eventuality and ceasing transmission of the PDU set can improve the efficiency of transmission of PDU sets in a wireless communication network.

Disclosed herein are procedures for efficient transmission of PDU sets in a wireless communication network. Said procedures may be implemented by a method in a node of a wireless communication network, a node in a wireless communications network, a method in a user equipment apparatus of a wireless communication network, and a user equipment apparatus for communicating with a wireless communication network.

Accordingly, there is provided a method in a node of a wireless communication network. The method comprises receiving from an application a protocol data unit (PDU) set corresponding to an encoded application data unit (ADU), whereby the encoding is based on an Application-Layer Forward Error Correction (AL-FEC) coding configuration. The method further comprises receiving an Application-Layer Forward Error Correction (AL-FEC) coding configuration that was used to encode the encoded ADU; and processing a transmission of the PDU set. The method further comprises determining if a cease criterion is met, the cease criterion derived for the PDU set from the AL-FEC coding configuration, and if a cease criterion is met for the PDU set, then ceasing transmission of the PDU set.

The determination of the AL-FEC encoded PDU sets, associated signaling of AL-FEC awareness and PDU sets metadata enable optimizations of downstream processing. In an embodiment, the latter information is processed by a RAN node for the purpose of one or more PDUs dropping out of a PDU set. Transmission may be ceased either when sufficient information is delivered to recover the ADU, or when sufficient information is lost that the ADU cannot be recovered. In either circumstance further transmission of PDUs in the PDU set would waste communication bandwidth. Ceasing transmission of the PDU set when a cease criterion is met thus prevents wasted transmissions. This results in more efficient bandwidth usage in the wireless communication network.

There is further provided a node in a wireless communications network, the node comprising a receiver and a processor. The receiver is arranged to receive from an application a protocol data unit (PDU) set corresponding to an encoded application data unit (ADU), whereby the encoding is based on an Application-Layer Forward Error Correction (AL-FEC) coding configuration. The processor is arranged to identify an Application-Layer Forward Error Correction (AL-FEC) coding configuration that was used to encode the encoded ADU. The processor is further arranged to process a transmission of the PDU set. The processor is further arranged to determine if a cease criterion is met, the cease criterion derived for the PDU set from the AL-FEC coding configuration, and if a cease criterion is met for the PDU set, then ceasing transmission of the PDU set.

The node may comprise a base station (gNB) where the PDUs travel in a downlink direction. The node may comprise a user equipment (UE) where the PDUs travel in an uplink direction. The application may comprise an application server or an application client. Processing transmission of the PDU set comprises sending PDUs of the PDU set to a transmitter transceiver for transmission.

There is further provided a method in a user equipment apparatus of a wireless communication network. The method comprises receiving a subset of protocol data units (PDUs) of a PDU set, the PDU set corresponding to an encoded application data unit (ADU) and an Application-Level Forward Error Correction (AL-FEC) coding configuration, whereby the encoding of the encoded ADU is based on the AL-FEC coding configuration. The method further comprises transmitting delivery acknowledgements in response to the received PDUs, and receiving an indication that no further PDUs belonging to the PDU set will be transmitted. The method further still comprises processing the decoding of the encoded ADU based on the received AL-FEC coding configuration and on the received subset of PDUs.

There is further provided a user equipment apparatus for communicating with a wireless communication network, the user equipment apparatus comprising a receiver a transmitter and a processor. The receiver is arranged to receive a subset of protocol data units (PDUs) of a PDU set, the PDU set corresponding to an encoded application data unit (ADU) and an Application-Level Forward Error Correction (AL-FEC) coding configuration, whereby the encoding of the encoded ADU is based on the AL-FEC coding configuration. The transmitter is arranged to transmit delivery acknowledgements in response to the received PDUs. The receiver is further arranged to receive an indication that no further PDUs belonging to the PDU set will be transmitted. The processor is arranged to decode the encoded ADU based on the received AL-FEC coding configuration and on the received subset of PDUs.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for efficient transmission of PDU sets in a wireless communication network will now be described, by way of example only, with reference to the accompanying drawings, in which:

FIG. 1 depicts an embodiment of a wireless communication system for efficient transmission of PDU sets in a wireless communication network in a wireless communication network;

FIG. 2 depicts a user equipment apparatus that may be used for implementing the methods described herein;

FIG. 3 depicts further details of the network node that may be used for implementing the methods described herein;

FIG. 4 illustrates a method in a node of a wireless communication network;

FIG. 5 illustrates an overview of a core network architecture handling PDU sets for a content delivery example of XR media;

FIG. 6 provides an overview of the RTP and RTCP stack;

FIG. 7 illustrates an overview of the WebRTC stack;

FIG. 8 illustrates packet format and header information for both an RTP packet and an SRTP packet;

FIG. 9 is an illustration of an AL-FEC XR application flow including encoding, packetization and transport;

FIG. 10 shows an encoding process output of a source flow corresponding to the encoded source PDUs, and a repair flow corresponding to the encoded repair PDUs;

FIG. 11 illustrates an architecture and procedures for information exchange in support of AL-FEC encoded PDU set determination for DL and UL directions;

FIG. 12 illustrates the determination of an AL-FEC encoded PDU set comprised of a first subset of source PDUs and a second subset of repair PDUs;

FIG. 13 illustrates a 5GS GTP-U data plane protocol stack of a PDU session;

FIG. 14 illustrates the structure of the GTP-U header;

FIG. 15 presents an example of a minimal size extension header of an AL-FEC encoded PDU set;

FIG. 16 illustrates three example RAN dropping policies of PDUs of AL-FEC encoded PDU sets; and

FIG. 17 illustrates a method in a user equipment apparatus of a wireless communication network.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of”′ includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures.

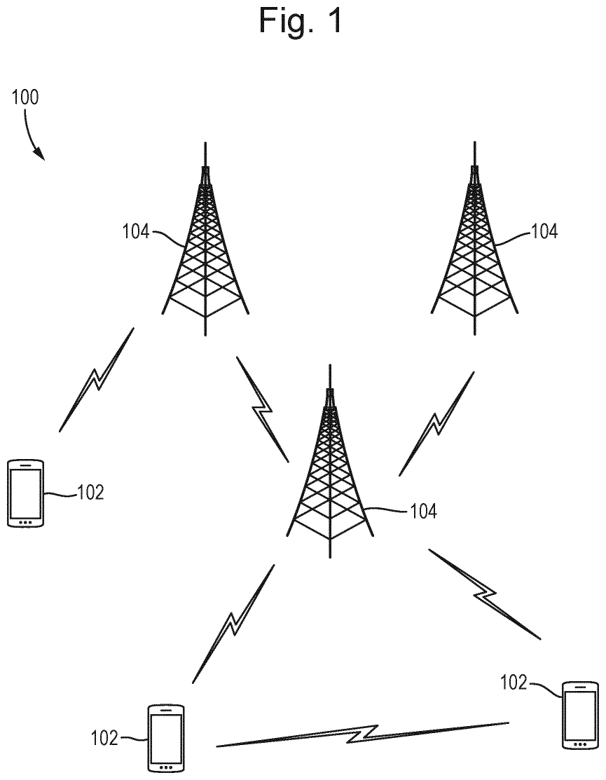

FIG. 1 depicts an embodiment of a wireless communication system 100 for efficient transmission of PDU sets in a wireless communication network in a wireless communication network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100. The remote unit 102 may comprise a user equipment apparatus 200, a sender 900, or a UE 535, 1135, 1310 as described herein. The base unit 104 may comprise a network node 300, or a UPF 540, 1140, 1340 as described herein.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WIMAX, IEEE 802.11 variants, GSM, GPRS, UMTS, LTE variants, CDMA2000, Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

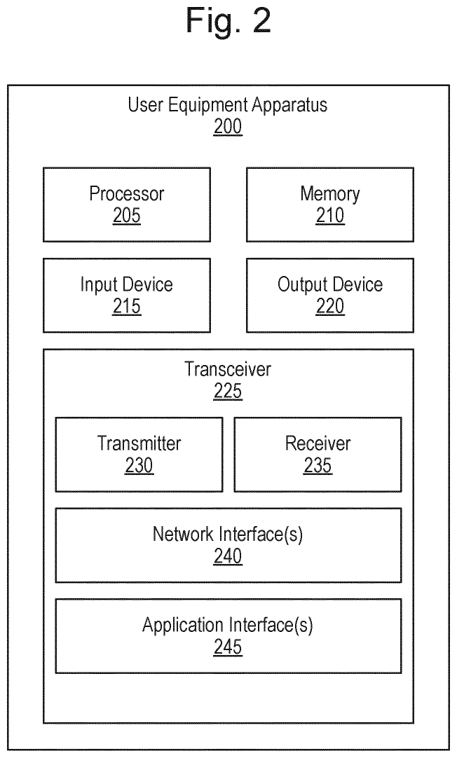

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise a remote unit 102, a sender 900, or a UE 535, 1135, 1310 as described herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communications network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

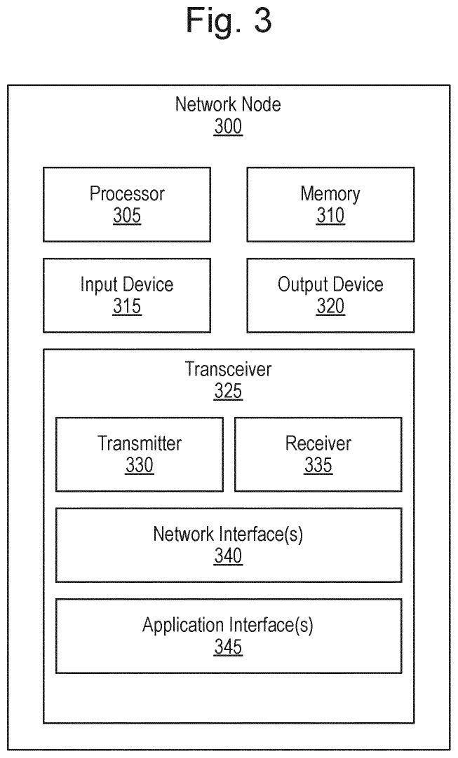

FIG. 3 depicts further details of the network node 300 that may be used for implementing the methods described herein. The network node 300 may comprise a base unit 104, or a UPF 540, 1140, 1340 as described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

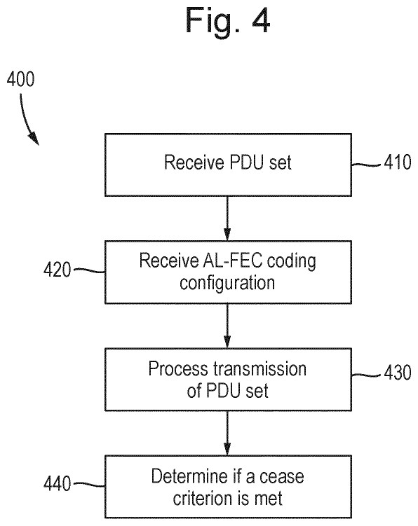

FIG. 4 illustrates a method 400 in a node of a wireless communication network. The method comprises receiving 410 from an application a protocol data unit (PDU) set corresponding to an encoded application data unit (ADU), whereby the encoding is based on an Application-Layer Forward Error Correction (AL-FEC) coding configuration. The method further comprises receiving 420 an Application-Layer Forward Error Correction (AL-FEC) coding configuration that was used to encode the encoded ADU; and processing 430 a transmission of the PDU set. The method further comprises determining 440 if a cease criterion is met, the cease criterion derived for the PDU set from the AL-FEC coding configuration, and if a cease criterion is met for the PDU set, then ceasing transmission of the PDU set.

The determination of the AL-FEC encoded PDU sets, associated signaling of AL-FEC awareness and PDU sets metadata enable optimizations of downstream processing. In an embodiment, the latter information is processed by a RAN node for the purpose of one or more PDUs dropping out of a PDU set. Transmission may be ceased either when sufficient information is delivered to recover the ADU, or when sufficient information is lost that the ADU cannot be recovered. In either circumstance further transmission of PDUs in the PDU set would waste communication bandwidth. Ceasing transmission of the PDU set when a cease criterion is met thus prevents wasted transmissions. This results in more efficient bandwidth usage in the wireless communication network.

Processing transmission of the PDU set comprises sending PDUs of the PDU set to a transmitter for transmission. Ceasing transmission of the PDU set may comprise transmitting an indication that no further PDUs belonging to the PDU set will be transmitted.

The received PDU set may comprise both a plurality of source PDUs and a plurality of repair PDUs, wherein the repair PDUs are associated to the source PDUs based on an encoding with the AL-FEC coding configuration. The repair PDUs may be recovery PDUs. The cease criterion may comprise a threshold of minimum necessary PDUs of the encoded PDU set required to recover the encoded ADU.

The determination of the threshold of minimum necessary PDUs may be based in part on the determined AL-FEC coding scheme configuration further containing at least one of: an encoding rate indication; an indication of the plurality of source PDUs and an indication of the plurality of repair PDUs; an explicit indication of a minimum number of PDUs within the encoded PDU set that need to be transmitted for the ADU to be recovered; an associated QoS flow requirement of a PDU error rate; and an associated QoS flow requirement of a PDU set error rate.

The encoding rate indication may comprise a ratio of a number of source encoding symbols comprised within the source PDUs and a total number of encoding symbols comprised within the encoded PDU set, a redundancy level corresponding to a percentage of repair PDUs to source PDUs of the encoded PDU set, and/or a number of source PDUs and a number of total PDUs contained in the encoded PDU set. The indication of the subset of source PDUs and an indication of the subset of repair PDUs may comprise PDU set marking the source PDUs and repair PDUs by a one bit field within the GTP-U header.

The cease criterion may comprise successful transmission of a number of PDUs of the PDU set, the number greater than or equal to the threshold of minimum necessary PDUs required to recover the ADU. The cease criterion may correspond to a successful transmission of the PDU set encoded ADU information by recovery of the ADU information. The cease criterion may comprise successful transmission of a number of PDUs of the PDU set, the number greater than or equal to the total number of PDUs in the PDU set minus a threshold of maximum number of PDUs that can be lost from the PDU set but still allow the ADU to be recovered. The threshold of maximum number of PDUs that can be lost from the PDU set but still allow the ADU to be recovered is the mathematical complement with respect to the total number of PDUs of the PDU set of the threshold of minimum necessary PDUs required to recover the ADU.

The cease criterion may comprise an unsuccessful transmission of a second number of PDUs of the PDU set, wherein the second number of PDUs is greater than or equal to the total number of PDUs in the PDU set minus the threshold of minimum necessary PDUs required to recover the ADU. The cease criterion may correspond to an unsuccessful transmission of the PDU set encoded ADU information. The cease criterion may comprise unsuccessful transmission of a number of PDUs of the PDU set, the number greater than or equal to a threshold of a maximum number of PDUs that can be lost from the PDU set but still allow the ADU to be recovered. The threshold of the maximum number of PDUs that can be lost from the PDU set but still allow the ADU to be recovered is the mathematical complement with respect to the total number of PDUs of the PDU set of the threshold of minimum necessary PDUs required to recover the ADU.

The cease criterion may comprise successful transmission of the source PDUs. Determining whether the cease criterion is met may be determined from the delivery acknowledgements received by the node. A delivery acknowledgement may be transmitted in reply to each received PDU.

The determination may be made dependent on the number and/or nature of the delivery acknowledgments. The delivery acknowledgement may comprise a hybrid automatic repeat request acknowledgement and/or an automatic repeat request acknowledgement. The nature of a delivery acknowledgement may comprise delivery acknowledged, or delivery not acknowledged.

There is further provided a node in a wireless communications network, the node comprising a receiver and a processor. The receiver is arranged to receive from an application a protocol data unit (PDU) set corresponding to an encoded application data unit (ADU), whereby the encoding is based on an Application-Layer Forward Error Correction (AL-FEC) coding configuration. The processor is arranged to identify an Application-Layer Forward Error Correction (AL-FEC) coding configuration that was used to encode the encoded ADU. The processor is further arranged to process a transmission of the PDU set. The processor is further arranged to determine if a cease criterion is met, the cease criterion derived for the PDU set from the AL-FEC coding configuration, and if a cease criterion is met for the PDU set, then ceasing transmission of the PDU set.

The node may comprise a base station (gNB) where the PDUs travel in a downlink direction. The node may comprise a user equipment (UE) where the PDUs travel in an uplink direction. The application may comprise an application server or an application client. Processing transmission of the PDU set comprises sending PDUs of the PDU set to a transmitter transceiver for transmission.

The received PDU set may comprise both a plurality of source PDUs and a plurality of repair PDUs, wherein the repair PDUs are associated to the source PDUs based on an encoding with the AL-FEC coding configuration. The repair PDUs may be recovery PDUs. The cease criterion may comprise a threshold of minimum necessary PDUs of the encoded PDU set required to recover the encoded ADU.

The determination of the threshold of minimum necessary PDUs may be based in part on the determined AL-FEC coding scheme configuration further containing at least one of: an encoding rate indication; an indication of the plurality of source PDUs and an indication of the plurality of repair PDUs; an explicit indication of a minimum number of PDUs within the encoded PDU set that need to be transmitted for the ADU to be recovered; an associated QoS flow requirement of a PDU error rate; and an associated QoS flow requirement of a PDU set error rate.

The encoding rate indication may comprise a ratio of a number of source encoding symbols comprised within the source PDUs and a total number of encoding symbols comprised within the encoded PDU set, a redundancy level corresponding to a percentage of repair PDUs to source PDUs of the encoded PDU set, and/or a number of source PDUs and a number of total PDUs contained in the encoded PDU set. The indication of the subset of source PDUs and an indication of the subset of repair PDUs may comprise PDU set marking the source PDUs and repair PDUs by a one bit field within the GTP-U header.

The cease criterion may comprise successful transmission of a number of PDUs of the PDU set, the number greater than or equal to the threshold of minimum necessary PDUs required to recover the ADU. The cease criterion may correspond to a successful transmission of the PDU set encoded ADU information by recovery of the ADU information. The cease criterion may comprise successful transmission of a number of PDUs of the PDU set, the number greater than or equal to the total number of PDUs in the PDU set minus a threshold of maximum number of PDUs that can be lost from the PDU set but still allow the ADU to be recovered. The threshold of maximum number of PDUs that can be lost from the PDU set but still allow the ADU to be recovered is the mathematical complement with respect to the total number of PDUs of the PDU set of the threshold of minimum necessary PDUs required to recover the ADU.

The cease criterion may comprise an unsuccessful transmission of a second number of PDUs of the PDU set, wherein the second number of PDUs is greater than or equal to the total number of PDUs in the PDU set minus the threshold of minimum necessary PDUs required to recover the ADU. The cease criterion may correspond to an unsuccessful transmission of the PDU set encoded ADU information. The cease criterion may comprise unsuccessful transmission of a number of PDUs of the PDU set, the number greater than or equal to a threshold of a maximum number of PDUs that can be lost from the PDU set but still allow the ADU to be recovered. The threshold of maximum number of PDUs that can be lost from the PDU set but still allow the ADU to be recovered is the mathematical complement with respect to the total number of PDUs of the PDU set of the threshold of minimum necessary PDUs required to recover the ADU.

Determining whether the cease criterion is met may be determined from the delivery acknowledgements received by the node. The determination may be made dependent on the number and/or nature of the delivery acknowledgments. The delivery acknowledgement may comprise a hybrid automatic repeat request acknowledgement and/or an automatic repeat request acknowledgement. The nature of a delivery acknowledgement may comprise delivery acknowledged, or delivery not acknowledged.

The study of NR Media (XRM) at the CN level in Release 18 of the 3GPP technical standards introduced the concept of a PDU set to handle QoS requirements of IRM applications and streams with a better granularity beyond QoS flow possibilities. As such, according to 3GPP Technical Report TR 23.700-60 (v0.0.3), a PDU set is composed of one or more PDUs carrying the payload of one unit of information generated at the application level (e.g. a frame or video slice for NRM Services). In some implementations all PDUs in a PDU set are needed by the application layer to use the corresponding unit of information. In other implementations, the application layer can still recover parts or all of the information unit, when some PDUs are missing.

In addition, the PDU set is associated with QoS requirements in terms of delay budget and error rate, which may be defined as PDU Set Delay Budget (PSDB), and/or as a PDU Set Error Rate (PSER). The PDU Set Delay Budget (PSDB) defines an upper bound for the time that a PDU set may be delayed between the UE and the N6 termination point at the UPF. PSDB applies to the DL PDU set received by the UPF over the N6 interface, and to the UL PDU set sent by the UE, respectively. The PDU Set Error Rate (PSER) defines an upper bound for the rate of PDU sets (e.g. set of IP packets constituting a PDU set) that have been processed by the sender of a link layer protocol (e.g. RLC in RAN of a 3GPP access) but where all of the PDUs in the PDU set are not successfully delivered by the corresponding receiver to the upper layer (e.g. PDCP in RAN of a 3GPP access). The PSER may be used to determine an upper bound for a rate of non-congestion-related packet losses.

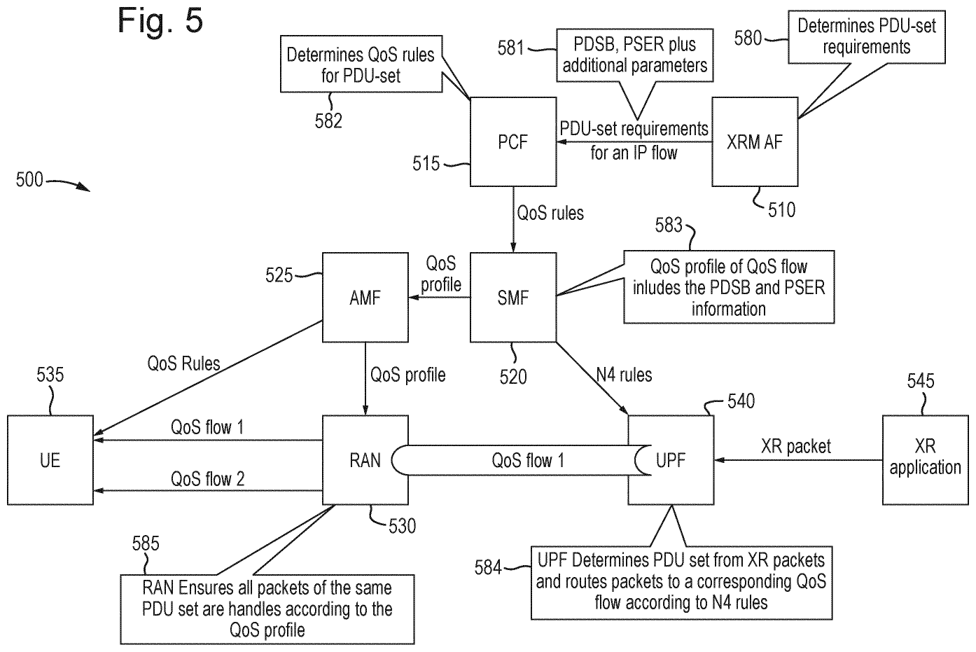

FIG. 5 illustrates an overview of a core network (CN) ARM architecture handling of PDU sets. FIG. 5 shows a system 500 comprising an Extended Reality Media Application Function (XRM AF) 510, a Policy and Control Function (PCF) 515, a Session Management Function (SMF) 520, an Access and Mobility Function (AMF) 525, a Radio Access Network (RAN) 530, a User Equipment (UE) 535, a User Plane Function (UPF) 540, and an Extended Reality Application 545. The UE 535 may comprise a remote unit 102, a user equipment apparatus 200, a sender 900, or a UE 1135, 1310 as described herein. The UPF 540 may comprise a base unit 104, a network node 300, or a UPF 1140, 1340 as described herein. The operation of system 500 will now be described in the example of downlink traffic, a similar process may operate for uplink traffic.

At 580, the XRM AF 510 determines PDU set requirements.

At 581, the XRM Application Function 510 provides QoS requirements for packets of a PDU set to the PCF 515 and information to identify the application (i.e. 5-tuple or application id). The QoS requirements may comprise PSDB and PSER. The NRM AF 510 may also include an importance parameter for a PDU set and information for the core network to identify packets belonging to a PDU set.

At 582, the PCF 515 derives QoS rules for the NR application and specific QoS requirements for the PDU set. The QoS rules may use a 5G QoS identifier (5Q1) for NR media traffic. The PCF 515 sends the QoS rules to the SMF 520. The PCF 515 may include in the communication to the SMF 520 Policy and Charging Control (PCC) rules per importance of a PDU set. The PCC rules may be derived according to information received from the XRM AF 510 or based on an operator configuration.

At 583, the SMF 520 establishes a QoS flow according to the QoS rules by the PCF 515 and configures the UPF to route packets of the NR application to a QoS flow, and, in addition, to enable PDU set handling. The SMF 520 also provides the QoS profile containing PDU set QoS requirements to the RAN 530 via the AMF 525. The AMF 525 may provide the QoS profile containing PDU set QoS requirements to the RAN 530 in an N2 Session Management (SM) container. Further, the AMF 525 may provide the QoS rules to the UE 535 in an N1 SM container.

At 584, the UPF 540 inspects the packets and determines packets belonging to a PDU set. The packet inspection may comprise inspecting the RTP packets. When the UPF 540 detects packets of a PDU set the UPF 540 marks the packets belonging to a PDU set within a GTP-U header. The GTP-U header information includes a PDU set sequence number and the size of the PDU set. The UPF 540 may also determine the importance of the PDU set either based on UPF 540 implementation means, information provided by the XRM AF 510 or information provided as metadata from an ARM application server. Based on the importance of the PDU set the UPF 540 may route the traffic to a corresponding QoS flow 1 (according to the rules received from the SMF 520) or include the importance of the PDU set within a GTP-U header. QoS flow 1 may comprise GTP-U headers, and these may include PDU set information.

At 585, the RAN 530 identifies packets belonging to a PDU set (based on the GTP-U marking) and handles the packets of the PDU set according to the QoS requirements of the PDU set provided by the SMF 520. In one implementation the RAN 530 node may use a different radio bearer with higher QoS requirement (according to the PDU set PSDB/PSER) to guarantee delivery of the packets of the PDU set, while using a different radio bearer according to the 5QI of the QoS flow for the non-PDU set packets. RAN 530 may receive QFIs, QoS profile of QoS flow from SMF 520 (via AMF 525) during PDU session establishment/modification which includes PDSB and PSER. RAN 530 inspects GTP-U headers and ensures all packets of the same PDU set are handled according to the QoS profile. This may include packets of PDU set in a radio bearer carrying QoS flow 1. This may also include sending packets not belonging to the PDU set in a different radio bearer carrying QoS flow 2.

The above example relates to downlink (DL) traffic. Reciprocal processing is applicable to uplink (UL) traffic wherein the role of UPF 540 packet inspection is taken by the UE 535 which is expected to inspect uplink packets, determine packets belonging to a PDU set, and signal accordingly the PDU set to the RAN 530 for scheduling and resource allocation corresponding to an associated DRB capable of fulfilling the PDU set QoS requirements (i.e., PSDB and PSER). The low-level signaling mechanism associated with the UL UE-to-RAN information passing are up to the specification and implementations of RAN signaling procedures.

Herein, extended Reality (NR) is used as an umbrella term for different types of realities, of which Virtual Reality, Augmented Reality, and Mixed Reality are examples.

Virtual Reality (VR) is a rendered version of a delivered visual and audio scene. The rendering is in this case designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated to ensure that, from the user's perspective, items and sound sources remain consistent with the user's movements. In some implementations additional means to interact with the virtual reality simulation may be provided but are not strictly necessary.

Augmented Reality (AR) is when a user is provided with additional information or artificially generated items, or content overlaid upon their current environment. Such additional information or content will usually be visual and/or audible and their observation of their current environment may be direct, with no intermediate sensing, processing, and rendering, or indirect, where their perception of their environment is relayed via sensors and may be enhanced or processed.

Mixed Reality (MR) is an advanced form of AR where some virtual elements are inserted into the physical scene with the intent to provide the illusion that these elements are part of the real scene.

XR refers to all real-and-virtual combined environments and human-machine interactions generated by computer technology and wearables. It includes representative forms such as AR, MR and VR and the areas interpolated among them. The levels of virtuality range from partially sensory inputs to fully immersive VR. In some circles, a key aspect of XR is considered to be the extension of human experiences especially relating to the senses of existence (represented by VR) and the acquisition of cognition (represented by AR).

In 3GPP Release 17, 3GPP SA4 Working Group analyzed the Media transport Protocol and NR traffic model in the Technical Report TR 26.926 (v1.1.0) titled “Traffic Models and Quality Evaluation Methods for Media and NR Services in 5G Systems”, and decided the QoS requirements in terms of delay budget, data rate and error rate necessary for a satisfactory experience at the application level. These led to 4 additional 5G QoS Identifiers (5QIs) for the 5GS XR QoS flows. These 5Qis are defined in 3GPP TS 23.501 (v17.5.0), Table 5.7.4-1, presented there as delay-critical GBR 5QIs valued 87-90. The latter are applicable to XR video streams and control metadata necessary to provide the immersive and interactive NR experiences.

The NR video traffic is mainly composed of multiple DL/UL video streams of high resolution (e.g., at least 1080p dual-eye buffer usually), frames-per-second (e.g., 60+ fps) and high bandwidth (e.g., usually at least 20-30 Mbps) which needs to be transmitted across a network with minimal delay (typically upper bounded by 15-20 ms) to maintain a reduced end-to-end application round-trip interaction delay. The latter requirements are of critical importance given the NR application dependency on cloud/edge processing (e.g., content downloading, viewport generation and configuration, viewport update, viewport rendering, media encoding/transcoding etc.).

To support such stringent delay-critical requirements specific to real-time communications (RTC) with high bandwidth (e.g., NR video streams) the envisioned higher-layer protocols for delivery of XR immersive multimedia applications is the Real-time Transport Protocol (RTP). In this context reference may be made to 3GPP Technical Report TR 26.928 (v17.0.0) titled “Extended Reality (NR) in 5G”. In some implementations, secured RTP variants such as vanilla Secure Real-time Transport Protocol (SRTP) or web browser based WebRTC stacks may be used to serve NR applications across mobile communications networks such as 5GS and alike.

RTP is a media codec agnostic network protocol with application-layer framing used to deliver multimedia (e.g., audio, video etc.) in real-time over IP networks, as defined in IETF standard RFC 3550 titled “RTP: A Transport Protocol for Real-Time Applications”. It is used in conjunction with a sister protocol for control, RTP Control Protocol (RTCP) to provide end-to-end features such as jitter compensation, packet loss and out-of-order delivery detection, synchronization and source streams multiplexing.

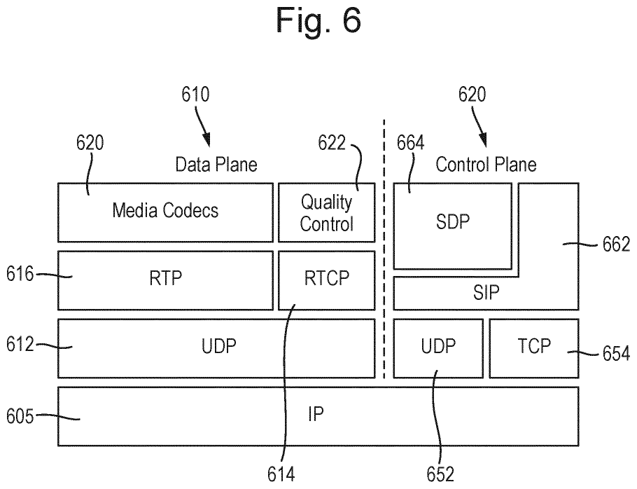

FIG. 6 provides an overview of the RTP and RTCP stack. An IP layer 605 carries signalling from the media session data plane 610 and from the media session control plane 650. The data plane 610 stack comprises functions for a User Datagram Protocol (UDP) 612, RTP 616, RTCP 614, Media codecs 620 and quality control 622. The control plane 650 stack comprises functions for UDP 652, Transmission Control Protocol (TCP) 654, Session Initiation Protocol (SIP) 662 and Session Description Protocol (SDP) 664.

SRTP is a secured version of RTP, and is defined by the IETF in RFC 3711 “The Secure Real-time Transport Protocol (SRTP)”. SRTP provides encryption (payload confidentiality), message authentication and integrity (header and payload signing), replay attack protection. Similarly, the SRTP sister protocol SRTCP provides the same functions to the RTCP counterpart. As such, in SRTP, the RTP header information is still accessible but non-modifiable, whereas the payload is encrypted. SRTP is used for this reason in the WebRTC stack which ensures secure RTC multimedia communications over web browser interfaces.

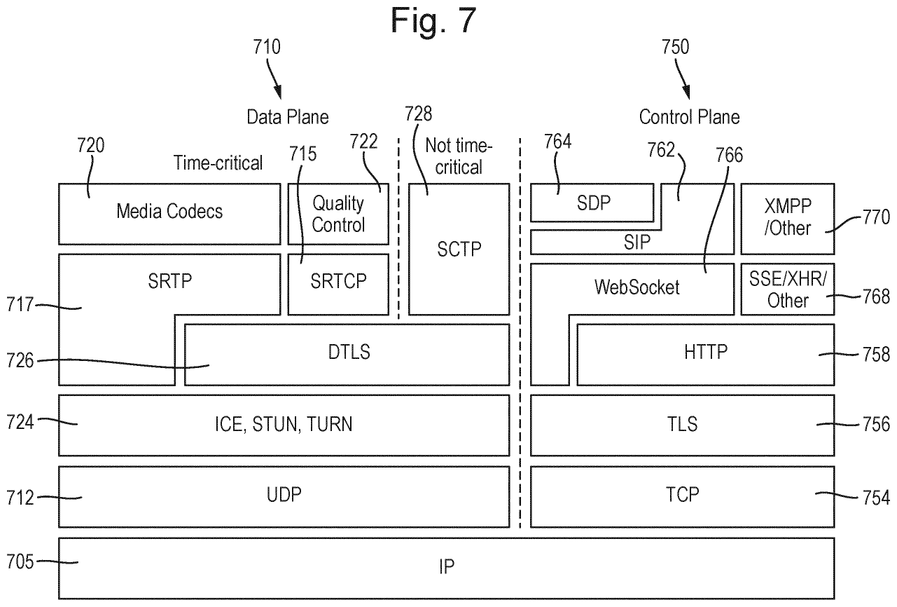

FIG. 7 illustrates an overview of the WebRTC stack. An IP layer 705 carries signalling from the data plane 710 and the control plane 750. The data plane 710 stack comprises functions for UDP 712, Interactive Connectivity Establishment (ICE) 724, Datagram Transport Layer Security (DTLS) 726, SRTP 717, SRTCP 715, media codes 720, Quality Control 722 and SCTP 728. ICE 724 may use the Session Traversal Utilities for NAT (STUN) protocol and Traversal Using Relays around NAT (TURN) to address real-time media content delivery across heterogeneous networks and NAT rules. SCTP 728 may be non time critical. SRTP 717, SRTCP 715, media codes 720, and Quality Control 722 may be time critical.

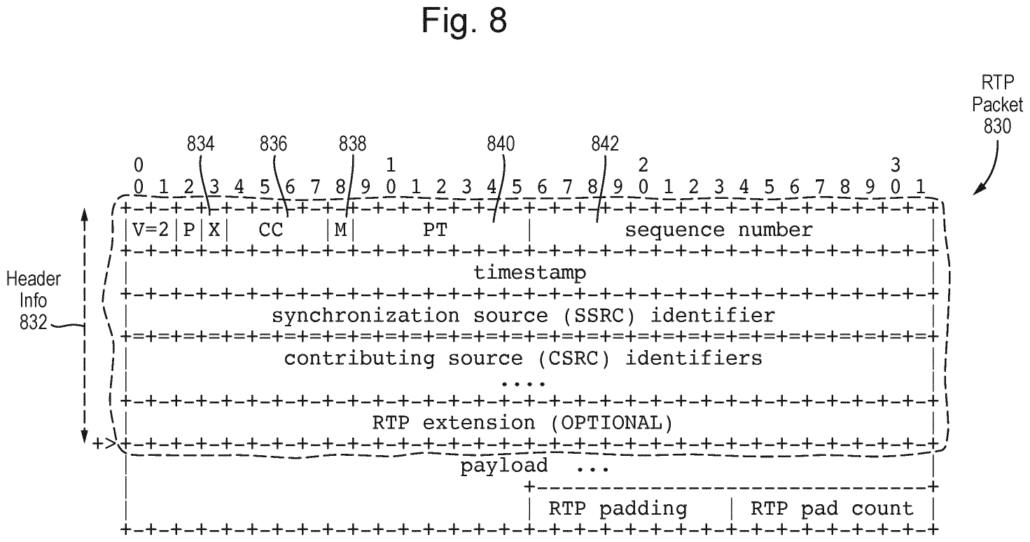

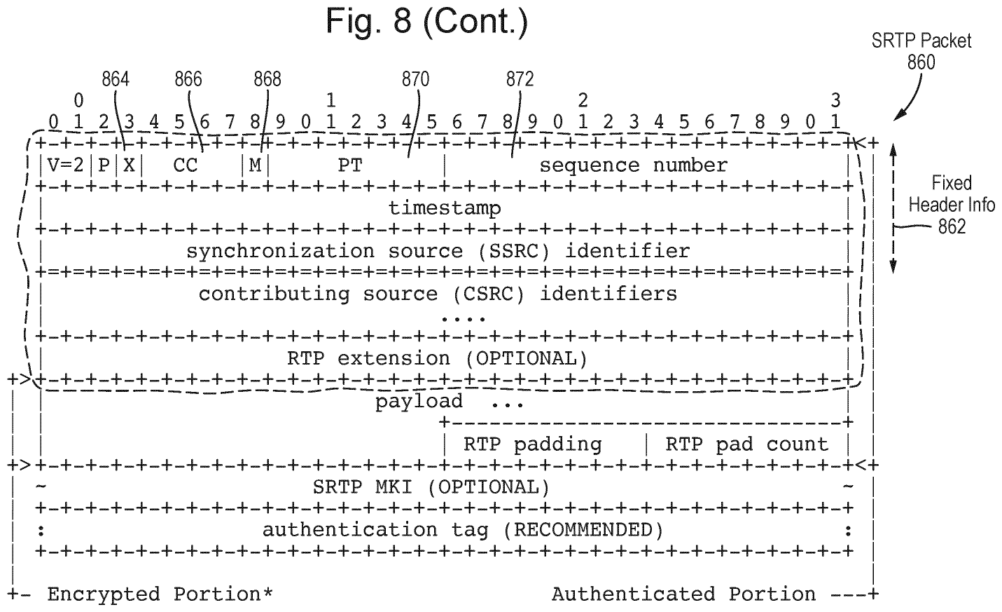

FIG. 8 illustrates packet format and header information for both an RTP packet 830 and an SRTP packet 860. The header information is available for inspection and processing and an overview is provided below including a brief description of certain fields of interest in the header portion of the RTP/SRTP packet formats

“X” 834, 864 is 1 bit indicating that the standard fixed RTP/SRTP header will be followed by an RTP header extension usually associated with a particular data/profile that will carry more information about the data (e.g., the frame marking RTP header extension for video data, as defined in RTP Frame Marking RTP Header Extension (November 2021)-draft-ietf-avtext-framemarking-13).

“CC” 836, 866 is 4 bits indicating number of contributing media sources (CSRC) that follow the header.

“M” 838, 868 is 1 bit intended to mark information frame boundaries in the packet stream, whose behaviour is exactly specified by RTP profiles (e.g., H.264, H.265, H.266, AV1 etc.)

“PT” 840, 870 is 7 bits indicating the payload type, which in case of video profiles is dynamic and negotiated by means of SDP (e.g., 96 for H.264, 97 for H.265, 98 for AV1 etc.).

“Sequence number” 842, 872 is 16 bits indicating the sequence number which increments by one with each RTP data packet sent over a session.

“Timestamp” 844, 874 is 32 bits indicating timestamp in ticks of the payload type clock reflecting the sampling instant of the first octet of the RTP data packet (associated for video stream with a video frame), whereas the first timestamp of the first RTP packet is selected at random.

“Synchronization Source (SSRC) identifier” 846, 876 is a 32 bit field indicating a random identifier for the source of a stream of RTP packets forming a part of the same timing and sequence number space, such that a receiver may group packets based on synchronization source for playback.

Hereafter we refer to a video frame as a video coded representation of a still image presented in a sequence composing a video stream. On the other hand, a video frame may be composed of one or more video slices. A video slice is a coded video representation of a partition of a still image part of a video sequence. In some implementations video slices may be referred to rectangular partitions (e.g., tiles) of the still image (e.g., H.266, AV1), whereby in other implementations video slices may be raster scan partitions of the still image (e.g., H.264, H.265, H.266 etc.). Similarly, we refer to a video layer as a video coding element either as a temporal video layer meant to increase the frames per second resolution and temporal level of details of a video sequence or as a spatial video layer meant to increase the number of video coded pixels and spatial resolution of individual video frames of a video sequence. The abstract concepts of video frame, video slice and/or video layers are applicable to MPEG family of modern hybrid video codecs (i.e., H.264/H.265/H.266), as well as, other open video codecs such as AV1 or VP9. The encapsulation format of video coded data to RTP/SRTP payloads is specified by Internet Standards for each individual video codec, e.g., H.264 by RFC 6184, H.265 by RFC 7798, AV1 by, for example, RTP Payload Format For AV1 (aomediacodec.github.io).

Note that for an NR application the media codecs used and their configuration/configuration updates depend on the application implementation and these are usually negotiated between a sender and a receiver upon session establishment/session update (e.g., RTP/SRTP). To this end, Session Description Protocol (SDP) signaling is used either as standalone signaling procedure or as part of the Session Initiation Protocol (SIP).

In various interactive NR applications involving multi-point communication (e.g., conference, shared classroom etc.) application-layer forward error correction (FEC) is used as a method to combat congestion and packet loss. This is possible also in point-to-point communication whereby the application-layer FEC may exploit link path diversity either at the network routing level or at the physical layer. By way of example, in 5GS link path diversity may be provided by dual connectivity (DC), carrier aggregation (CA) as well as multi-TRP transmissions. This applies for instance to 1D/2D parity check codes (e.g. as defined in IETF RFC 8627), Raptor codes (e.g., as defined in IETF RFC 5032), RaptorQ codes (e.g., as defined in IETF RFC 6330), and LDPC staircase codes (e.g., as defined in IETF RFC 6816).

IETF has defined a generic forward error correction framework (FECFRAME) as IETF RFC 6363 which allows for various FEC Schemes to be applied for application-level FEC. FECFRAME specifies source packet and repair packet formats and FEC Scheme configuration procedures for AL-FEC both over transport layer (e.g., UDP), as well as over RTP layer or alike (e.g., WebRTC).

The forward error correction framework, FECFRAME, operates consequently on application data units (ADU), e.g., RTP packets in case RTP is used for encapsulation of media information units.

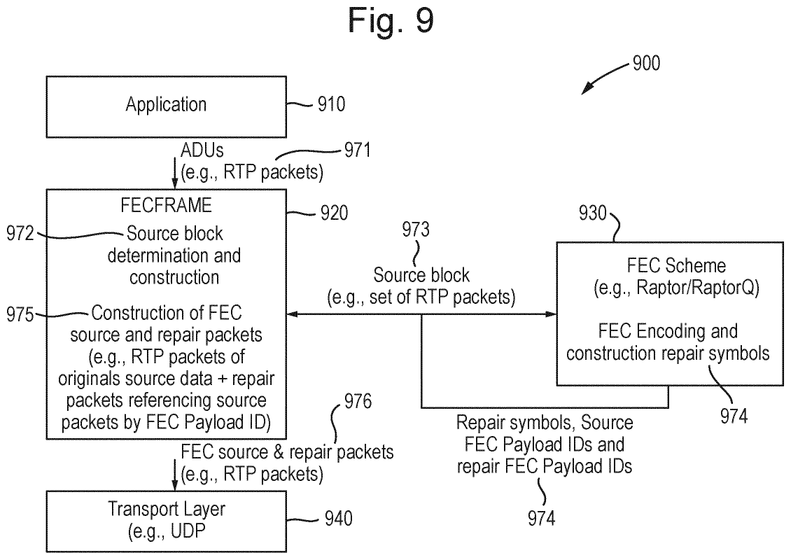

FIG. 9 is an illustration of an AL-FEC XR application flow including encoding, packetization and transport. This presents the role of FECFRAME and application of various FEC coding schemes. FIG. 9 shows a sender 900 comprising an application 910, a FECFRAME 920, a FEC scheme 930 and a transport layer 940. The sender 900 may comprise a remote unit 102, a user equipment apparatus 200, a UE 535, 1135, 1310, a base unit 104, a network node 300, or a UPF 540, 1140, 1340 as described herein.

In some embodiments, a popular AL-FEC coding scheme given its efficient encoding/decoding is Raptor coding (IETF RFC 5032), or alternatively, in other embodiments, its optimized version RaptorQ coding (IETF RFC 6330). Applied in the context of FECFRAME Raptor/RaptorQ encodes RTP packets as per IETF RFC 6881 and IETF RFC 6882. An example of some generic steps of this application flow are described as follows.

At 971, the application 910 in the sender 900 determines a set of source packets (e.g., RTP source packets) representing an ADU as a source block, to be protected jointly based on an AL-FEC coding configuration.

The AL-FEC coding configuration may comprise FECFRAME Configuration Information containing: a FEC Scheme identifier; a maximum source block length (MSBL) or alternatively K_max for Raptor/RaptorQ; an encoding symbol size (i.e., a T parameter for Raptor/RaptorQ coding schemes); and a repair-window duration (i.e., a maximum time in milliseconds and/or microseconds that spans the transmission of the source packets and the corresponding repair packets, whereby the transmission point is considered to be downstream interface ingesting encoded PDUs post-encoding)).

At 972, the sender arranges the source packets (e.g., the RTP source packets) into a set of same-sized source symbols (that may represent smaller partitions into source symbols of configured size of source packets data).

At 973 and 974, the sender applies FEC scheme 930 (e.g., Raptor/RaptorQ/2D parity codes) according to AL-FEC configuration (e.g., FECFRAME Configuration Information) to generate the required number of repair symbols.

At 975, the sender performs packetization of the repair symbols into repair packets (e.g., RTP repair packets according to IETF RFC 6882) and sends 976 the repair packets and the source packets via the transport layer 940 to a receiver.

Under FECFRAME requirements (i.e., IETF RFC 6363), the sender shall transmit the source and repair packets in different source and repair flows, e.g., RTP streams, to allow for legacy (non-FEC) applications processing of source packets similar to any systematic code.

The receiver receives source and repair packets. If all the source packets are successfully received, no FEC recovery is needed and the FEC repair packets can be discarded.

If there are however missing source packets the repair packets can be processed and used to recover the lost information within a latency corresponding to at least a repair-window time configured by the application FEC configuration.

Raptor/RaptorQ FEC Scheme recovery properties determine that recovery of K encoded source packets is possible from any K+h coded source or repair packets with a probability 1−1/256\hat{ }(h+1), whereby an encoded symbol corresponds to an encoded packet. This implies that recovering K encoded source symbols from a set of N encoded source and repair packets where only K+1 encoded packets have been received is guaranteed with essentially more than 99.99%, i.e., a very large probability. In other embodiments, whereby an encoded packet corresponds to more than one encoded symbol, a high probability of recovery is maintained also after packetization thus allowing Raptor/RaptorQ codes to achieve strong error correction performance.

In embodiments of FECFRAME for general flows, it is required that ADU source PDUs (e.g., the source RTP PDUs) contain an additional footer representing a Payload ID. This is used on the receiver side to determine if an encoded PDU is lost and to aid selection and usage of proper recovery slot for decoding missing packets based on the encoded available PDUs, i.e., either source or repair PDUs. In many embodiments where RTP/SRTP is used, this information is readily available as part of the RTP/SRTP sequence number which acts as a Payload ID replacement. In such embodiments the source RTP/SRTP packets resulting from a FECFRAME encoding are sent unchanged similarly to any systematic coding procedure. This provides backwards compatibility to receivers not supporting AL-FEC for example. In one embodiment the FEC encoding scheme used to encode the source and repair PDUs as RTP/SRTP packets is using therefore the sequence number of the original RTP/SRTP source packets as a Payload ID replacement (e.g., for Raptor/RaptorQ code, in Single Sequenced Flow encoding mode according to IETF RFC 6681). This indicates thus the dependency of encoded repair RTP/SRTP packets to the block of RTP/SRTP source packets jointly encoded aiding the decoder endpoint in efficient decoding.

To handle PDU sets for an NR QoS flow implies solving the problem of mapping traffic flow of an application to PDU sets. This corresponds to determining the PDU Set Boundaries (PSBs) (i.e., the start PSB and/or the end PSB of a PDU set).

This problem may be resolved either at the UPF for DL traffic or at the UE for UL traffic. The outcomes are subsequently used in DL as described in the prequel to setup, configure and map PDU sets to appropriate QoS rules by means of QoS flow. On the other hand, in UL the UE will use the determined PDU sets to map the PDU sets to particular DRBs which are subsequently mapped by the RAN over N3 to QoS flows by means of SDAP processing. The UPF shall then route the UL to an application server as per the PCF configured QoS rules and SMF setup QoS flow.

The PSBs determination considered by state-of-art is mainly performed by either or both of two approaches: Deep packet inspection, and RTP header information parsing. Deep packet inspection is however computational heavy with training and deployment requirements that make it infeasible for application in the UL direction for the UE processing.

Solutions that refer to using RTP packet format leverage a combination of one or more of the RTP timestamp, sequence number, payload type and M-bit marker to determine video frame boundaries. This information is complemented in some solutions by additional information extracted from application-specific and/or profile-specific RTP header extensions (e.g., draft-ietf-avtext-framemarking-13) or from parsing the RTP payload headers (e.g., of the video coded NAL units in H.26x codecs), as detailed in3GPP Technical Report TR 23.700-60 v0.0.3, titled “Study on NR (Extended Reality) and media services”.

However, these solutions do not consider AL-FEC traffic but refer only to non-encoded XR application traffic. Nonetheless, according to 3GPP SA4 Working Group (in particular 3GPP Liaison Statement from 3GPP SA4 WG to 3GPP SA2 WG, S4-220505 from SA4 Meeting #118e, 6th-12th April 2022), a PDU set may contain source and repair PDUs of an AL-FEC encoded source block, typical in multicast/broadcast as defined in 3GPP TS 26.246 v17.0.0 titled “Transparent end-to-end Packet-switched Streaming Service (PSS); 3GPP SMIL language profile”, or in conversational applications as described in 3GPP TS 26.114 v17.5.0 titled “IP Multimedia Subsystem (IMS); Multimedia telephony; Media handling and interaction”. This further motivates the determination of PDU sets for NR traffic encoded by an AL-FEC configuration and the associated encoded PDUs.

RAN PDU dropping has been discussed in the solution space of NR traffic handling in 5G for the case of dropping PDUs belonging to a scheduled XR ADU whose delay budget expired, or which is dependent on another ADU (e.g., a P-frame dependent on an I-frame reference) whose delay budget expired (see for example, 3GPP discussion document R1-2111787, titled “Discussion on enhancements for NR” submitted by Ericsson at RAN1 #107e, in November 2021).

Even though these solutions might be applied to PDU sets, these are not AL-FEC aware and simply react to the expiration of a delay budget or a higher layer indication that an information has become obsolete.

There is provided herein a proactive solution utilizing AL-FEC awareness to drop PDUs of encoded PDU sets whereby said PDUs either carry unnecessarily redundant information to the receiver (e.g., the receiver received already enough packets to decode the desired ADU information), or obsolete information to the receiver (e.g., the receiver cannot recover anymore the desired ADU information as too many PDU erasures have already happened).

As an aside it is noted that 3GPP TR 23.700-60 (v0.0.3) titled “Study on NR (Extended Reality) and media services” describes using RTP packet format to leverage a combination of one or more of the RTP timestamp, sequence number and M-bit marker to determine video frame boundaries. This information is complemented in some solutions by additional information extracted from application-specific and/or profile-specific RTP header extensions (e.g., draft-ietf-avtext-framemarking-13) or from parsing the RTP payload headers (e.g., of the video coded NAL units in H.26x codecs). This last collected information is then used to extract some classification/estimation of the importance of the detected PDU set.

The solution presented herein uses the same strategy of using the RTP header to determine some information of the encoded PDUs, yet in contrast to the prior-art, the method uses an AL-FEC configuration and knowledge of the encoded application traffic to determine a PDU set further containing 2 subsets representing encoded source PDUs and encoded repair PDUs as a common PDU set. The co-dependent source PDU and repair PDU are thus grouped together as a PDU set.

The solution presented herein tends to provide the handling and dropping of AL-FEC encoded PDU sets at the RAN using AL-FEC RAN awareness.

Three example policies may be applied to determine when to drop PDUs of AL-FEC encoded PDU sets. The RAN dropping is motivated by optimization of radio resource usage and allocation, and increase of system capacity by stopping transmission processing of PDUs of an encoded PDU set. This tends to provide more efficient transmission of PDU sets in a wireless communication network. The dropped PDUs are either:
unnecessarily redundant—i.e., the receiver received already enough PDUs belonging to the encoded PDU set to decode the desired ADU information; or
obsolete—i.e., the receiver cannot recover anymore the desired ADU information as too many PDU erasures have already happened.

The solution is enabled by receiving, determining and/or identifying an Application-Layer Forward Error Correction (AL-FEC) coding configuration that was used to encode the encoded ADU, and process a transmission of the PDU set accordingly. In certain embodiments, this may be facilitated by AL-FEC encoded ADU mapping to PDU sets and signaling of AL-FEC coding configuration information and PDU sets metadata. As such, the determined RAN PDU dropping policies applicable to AL-FEC encoded PDU sets are based on a threshold determination of minimum necessary PDUs for recovery of the encoded ADU information, and respectively, on the structure of PDU sets comprising of a first subset of source PDUs and a second subset of repair PDUs.

The usage of AL-FEC for encoding XR application ADUs results in encoded source and repair PDUs. In one embodiment this may be obtained as an outcome of FECFRAME (i.e., IETF RFC 6363) processing given an AL-FEC configuration of at least:
a configured source block size,
an AL-FEC encoding scheme (e.g., Raptor/RaptorQ, 1D/2D flexible parity check, staircase LDPC encoding etc.),
a coding rate and/or redundancy level, and
an encoding symbol size.

The source block determines the maximum ADU data size that can be encoded at once. In some embodiments for ADUs smaller in size that the configured source block, the ADU data is supplemented with padding bits up to the size of the source block. In other embodiments for ADUs larger in size than the source block, an ADU is split in multiple partitions sized smaller or equal than the source block of the AL-FEC configuration.

In some embodiments the encoding symbol size is configured to match a Maximum Transmission Unit (MTU) corresponding to a PDU such that one encoding symbol is contained in one PDU, as either a source PDU or a repair PDU. In such embodiments padding is applied to source PDUs smaller in size than the encoding symbol size in both encoding and decoding to match the encoding symbol size. The padding bits are not transmitted as their value and/or number are known to both AL-FEC encoder and decoder given the AL-FEC configuration.

In other embodiments the encoding symbol size is configured to be smaller than an MTU of a PDU. In such embodiments one or more encoding symbols comprise a PDU, as either a source PDU or a repair PDU. In such embodiments padding is applied to source PDUs smaller in size than the smallest integer number of encoding symbols larger or equal in size than the source PDU. In both encoding and decoding to match the integer number of encoding symbols, padding is applied to the source PDU. The padding bits are not transmitted as their value and/or number are known to both AL-FEC encoder and decoder given the AL-FEC configuration.

The AL-FEC encoding and packetization generates for each encoded ADU a number of encoded source PDUs and a number of repair PDUs. In some embodiments, the number of encoded source PDUs is determined by the number of source PDUs representing the ADU input (e.g., number of RTP packets in the source block corresponding to an ADU), and the number of repair PDUs is determined by the AL-FEC encoding configuration, respectively by the AL-FEC coding rate and/or redundancy level. In an example, a number of K source PDUs is encoded to a number of K encoded source PDUs which are the same as the source PDUs, and respectively, a number of N−K>0 encoded repair PDUs corresponding to coding rate K/N<1, or equivalently, a redundancy level of (N−K)/K %.

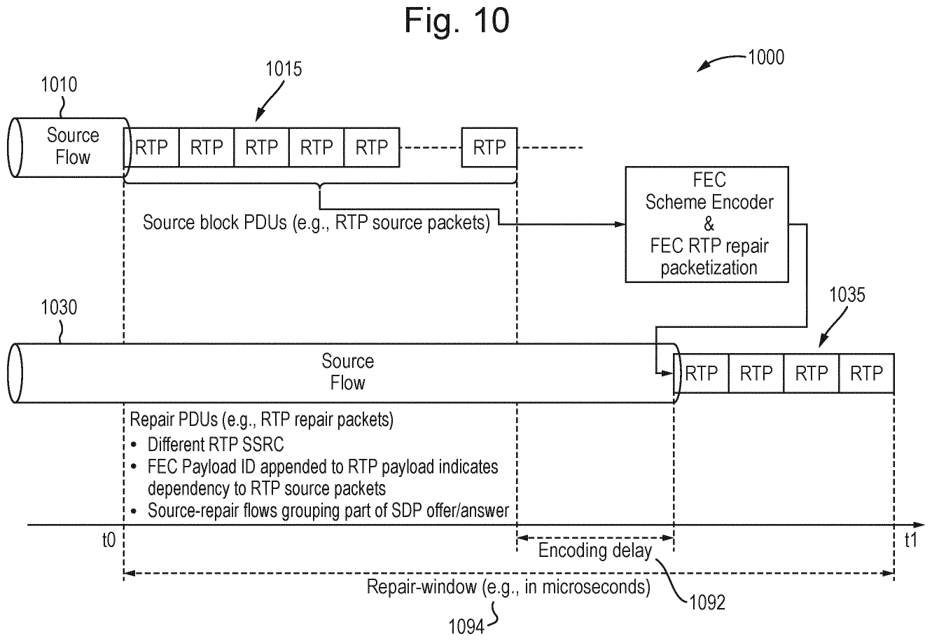

FIG. 10 shows an illustration of the encoding process 1000 of a source flow 1010 corresponding to the encoded source PDUs 1015, and a repair flow 1030 corresponding to the encoded repair PDUs 1035 . . . . The incoming RTP PDUs of the application are encoded and packetized by a systematic encoding. In such an embodiment, the source RTP PDUs remain unchanged post-encoding forming the systematic codeword of encoded source PDUs. In the same embodiment a block code comprising a FEC scheme encoder 1020 is used to encode the repair symbols up to the encoding symbols configured size and to packetize them in repair PDUs 1035 on the repair flow 1030. FIG. 10 also illustrates an encoding delay 1092 between the input encoded source PDUs 1015 and the corresponding encoded repair PDUs 1035. A repair window 1092 represents the time after an encoded source PDUs 1015 within which the corresponding encoded repair PDU 1035 might be used.

The source flow 1010 and repair flow 1030 may be transmitted over different RTP sessions, i.e., different source IP, source port addresses. In such embodiments, the co-dependent source and repair flows are associated at the media session level by a FEC grouping according to IETF RFC 5956 and IETF RFC 6364. Co-dependent source and repair flows are one or more flows such that the repair flows contain redundantly combined information of the source flows, depending on the latter. In similar fashion the source flows depend on the repair flows in case of errors, whereby redundant repair flows partial information can be used to recover the source flows information.

The FEC grouping is negotiated by the XR application during the SDP offer/answer procedure. In an example listing, the grouping of a source and repair flow within an SDP offer is determined as,

$$…$$

$$a = group : FEC - FR S 1 R 1$$

$$m = video 42420 RTP / AVP 100$$

$$c = IN IP 4 233.252 \text{.0} \text{.1} / 127$$

$$a = rtpmap : 100 H 264 / 90000$$

$$a = fec - source - flow : id = 0$$

$$a = mid : S 1$$

$$m = application 42420 UDP / FEC$$

$$c = IN IP 4 233.252 \text{.0} \text{.2} / 127$$

$$a = fec - repair - flow : encoding - id = 6 ; fssi = Kmax : 50 , T : 1280$$

$$a = repair - window : 15 ms$$

$$a = mid : R 1$$

$$…$$

In the example above, the group (S1, R1) is created. The S1 flow represents the fec-source-flow identified by ID=0, and the R1 flow represents the fec-repair-flow described by its encoding scheme (i.e., encoding-id=6 corresponding to RaptorQ for single sequenced source flows as described in IETF RFC 6681) and parameters T=1280 bytes encoding symbols whereas a source block contains at maximum a length of K_max=50 symbols. The two co-dependent flows are thus grouped logically at the media session level, albeit being delivered over two different RTP sessions.

In other embodiments the same source and repair flows as above are transmitted by an RTP multiplexer over a common RTP session, whereby the different SSRCs of the two flows are multiplexed together as part of an ssrc-group as defined in IETF RFC 5956 at the SDP protocol level. In such an example, the source and repair flows from above would be described in an SDP offer/answer procedure as defined in IETF RFC 6682 as

$$…$$

$$m = video 42420 RTP / AVP 100 \; 110$$

$$c = IN IP 4 233.252 \text{.0} \text{.1} / 127$$

$$a = rtpmap : 100 H 264 / 90000$$

$$a = rtpmap : 110 raptorfec / 90000$$

$$a = fmtp : 110 raptor - scheme - id = 6 ;$$

$$Kmax = 50 ; T = 1280 ; repair - window = 15000$$

$$a = ssrc : 1000000$$

$$a = ssrc : 1000110$$

$$a = ssrc - group : FEC - FR 1000000 \; 1000110$$

$$a = mid : FECGroup 1$$

$$…$$

In the example above the source flow (SSRC=1000000 and payload type=100) and repair flow (SSRC=1000110 and payload type=110) are multiplexed over the same RTP session, yet the encoding parameters are the same as in the previous example.

In some embodiments, the AL-FEC encoded and co-dependent media flows are therefore determined by a 5GS by monitoring of SDP offer/answer procedure associated with an XR application where an offer endpoint initiates an SDP offer to an answer endpoint. The answer endpoint replies to the SDP offer with an SDP answer agreeing to a particular set of media streams, attributes, and parameters among which is also the AL-FEC configuration. The co-dependent grouping of source and repair flows is determined in one embodiment based on the “group” SDP attribute, whereas in another embodiment it is determined based on the “ssrc-group” SDP attribute whereby RTP SSRC multiplexing is applied.

In other embodiments, the AL-FEC encoding configuration may be signalled by the AF of the XR application to the NEF Packet Flow Description Function (PFDF) API as part of a set of one or more Packet Flow Description (PFD) objects identifying various AL-FEC configurations based on at least one of
a 3-tuple including protocol, server-side IP and server-side port addresses;
a rule set of significant parts of an URL to be matched;
a rule set matching criterion of a domain name; and
an information enclosing protocol configuration (e.g., AL-FEC configuration such as coding rate, redundancy level, coding scheme, source block size, encoding symbol size, repair-window etc.).

In such an embodiment, the AF of the NR application will signal implicitly by control plane interfaces, e.g., NEF PFDF API, the AL-FEC configuration description to be applicable at the PDU session level for the encoded PDU traffic. The information thus signalled is managed according to the PFD management procedures by the SMF. The SMF informs the UPF of the PFD rules and the SMF informs the UPF also about the PCF determined PCC and QoS rules for the NR application traffic and AL-FEC associated coding configuration. The UPF can then apply the appropriate packet detection and filtering to determine the PDU sets containing the encoded co-dependent source PDUs as a subset and the repair PDUs as another subset.

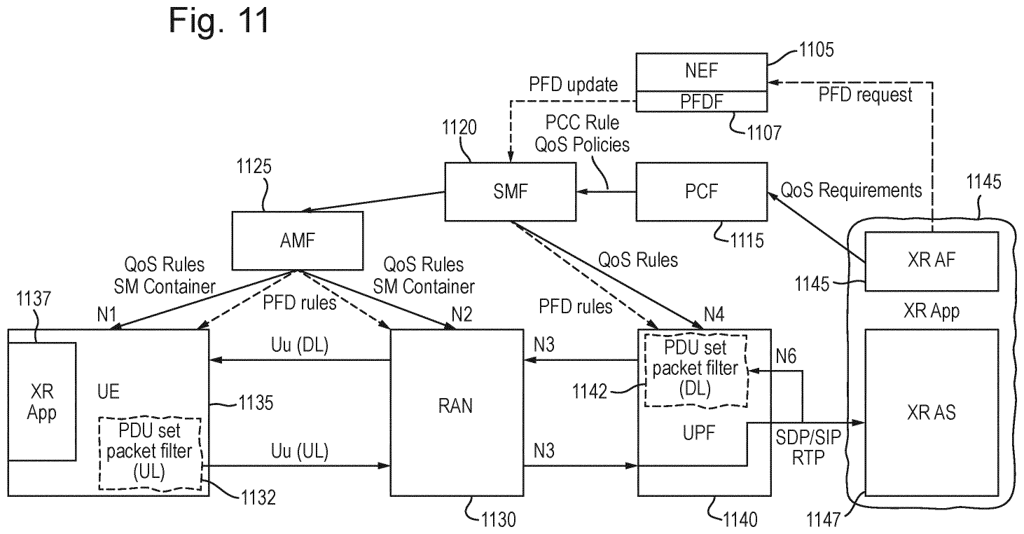

FIG. 11 illustrates an architecture and procedures for information exchange in support of AL-FEC encoded PDU set determination for DL and UL directions. FIG. 11 shows a system 1100 comprising an Extended Reality Media Application Function (XRM AF) 1110, that is part of an XR APP 1145. The NR APP 1145 includes an NR Application Service (AS) 1147. The system 1100 further comprises a Network Exposure Function (NEF) 1105 that includes a Packet Flow Description Function (PFDF) 1107. The system 1100 further comprises a Policy and Control Function (PCF) 1115, a Session Management Function (SMF) 1120, an Access and Mobility Function (AMF) 1125, a Radio Access Network (RAN) 1130, a User Equipment (UE) 1135, and a User Plane Function (UPF) 1140. The UE 1135 comprises a client XR Application 1137 and a PDU set packet filter 1132. The UPF 1140 comprises a PDU set packet filter 1142. The interfaces between certain components are additionally illustrated. The UE 1135 may comprise a remote unit 102, or a user equipment apparatus 200, a sender 900, or a UE 535, 1310 as described herein. The UPF 1140 may comprise a base unit 104, or a network node 300 or a UPF 540, 1340 as described herein.

Similarly, in another embodiment for UL transmissions the SMF can inform via the AMF the UE of the PFD rules and QoS rules for the NR application traffic. The UE can then apply for UL transmissions an appropriate packet detection and filtering to determine PDU sets containing the encoded co-dependent source PDUs as a subset and repair PDUs as another subset.

In some embodiments the PDU set, the encoded source PDUs subset and the encoded repair PDUs subset are determined by the inspection of the RTP and/or SRTP fixed header information either at the UPF for DL transmissions or at the UE for UL transmissions. This contains at least the following RTP/SRTP header fields which can be used to determine the boundaries of an encoded ADU spanning the source PDUs subset and repair PDUs subset:
the M-bit marker field,
the payload type field,
the SSRC field,
the sequence number field, and
the timestamp field.

The M-bit marker field may indicate by a bit value of ‘1’ the end boundary of an ADU's information (i.e., video frame) identifying the end of source ADUs and thus of the encoded source PDUs subset.

Alternatively, the M-bit marker field may indicate by a bit value of ‘1’ the end of the repair PDUs associated with a source block corresponding to a source ADU and as such to an encoded source PDUs.

The payload type field may indicate the type of each payload carried by the RTP PDU as one of a source PDU media payload type (e.g., H264, HEVC etc.) or a repair PDU type (e.g., corresponding to a configured AL-FEC encoded flow). In an example of any of the SDP configurations earlier presented, the payload type of the source PDUs is ‘100’, whereas the payload type of the repair PDUs ‘110’.

The SSRC identifiers may further indicate the main synchronization source of each RTP PDU whereby source and repair PDUs may be multiplexed within the same stream and as such complement the payload type field in indicating the encoded source PDUs and repair PDUs. In the example for ‘ssrc-group’ SDP grouping configuration of co-dependent source and repair flows, the SSRC of the source PDUs is ‘1000000’, whereas the SSRC of the repair PDUs is ‘1000110’.

The sequence number field may label in sequence the PDUs and may provide a means for ordering the PDUs of a PDU set based on their original sampling thus enabling the logic separation of a first subset of PDUs as the source PDUs and a second subset of PDUs as the repair PDUs of the PDU set. In an embodiment the source and repair PDUs may be however interleaved given a specific AL-FEC encoding scheme configuration. In another embodiment the source and repair PDUs of a PDU set are not interleaved with the source PDUs subset being transmitted first followed by a second subset comprising the co-dependent repair PDUs.

The timestamp field may aid synchronization of PDUs and indicates within a PDU set the sampling timestamp of each PDU. In some embodiments the timestamp of source and repair PDUs is the same, whereas in other embodiments the timestamp of source PDUs is set to a timestamp ‘t0’ corresponding to the sampling of the source ADU (e.g., a video frame captured by a capturing input device and stored into memory), and the timestamp of repair PDUs is set to a timestamp ‘t1’ corresponding to timestamp ‘t0’ plus an encoding delay due to the AL-FEC encoding processing. The encoding delay is less or equal than the repair-window AL-FEC configuration. In an embodiment, the encoding delay and repair-window are determined by the NR application server based at least on a maximum end-to-end content delivery delay requirement and/or an end-to-end application delay requirement.

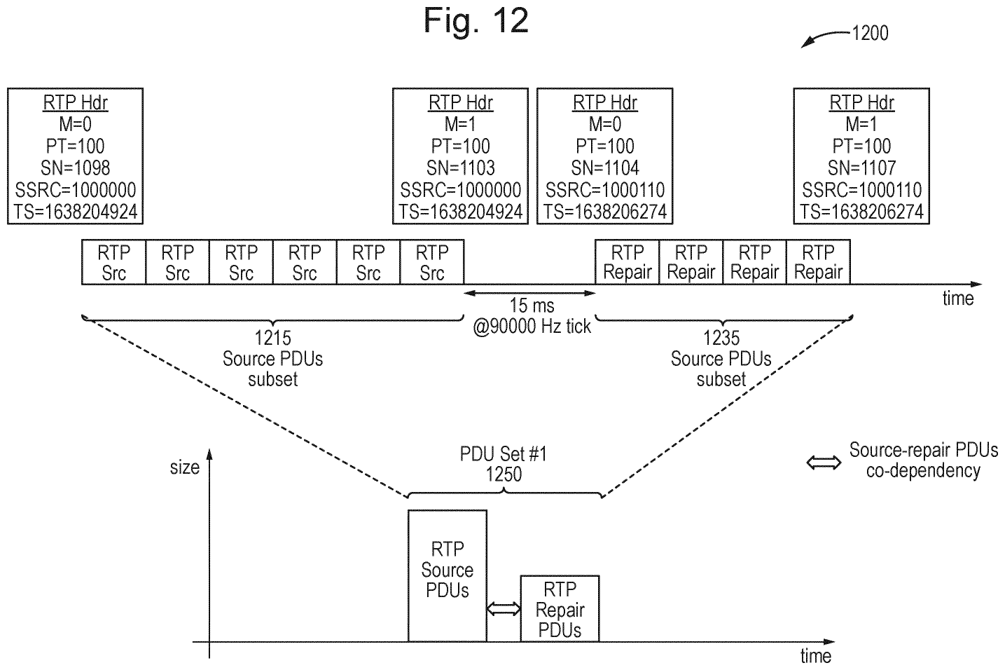

FIG. 12 illustrates the determination 1200 of an AL-FEC encoded PDU set 1250 comprised of a first subset of source PDUs 1215 and a second subset of repair PDUs 1235. The M-bit marker, payload type and/or SSRCs are used based on the SDP session information of the AL-FEC configuration to determine PDU sets. In addition, a first subset of the PDU set 1250 is determined comprising source PDUs 1215 and a second subset of the PDU set 1250 is determined comprising repair PDUs 1235, whereas the identification of the two is based on the payload type and/or SSRC RTP header field. It should be noted that the same processing may be performed with the same results for SRTP traffic.

To benefit of the determined AL-FEC encoded PDU set and encoded source PDUs subset and repair PDUs subset in downstream transmission and lower layer processing, the acquired PDU set information may be signaled to a RAN within a 5GS or alike. The backhaul transport within a 5GS is tunneling the PDU session traffic flows over an internal UDP/IP stack. The latter is performed by the GTP-U tunneling protocol enclosing an external IP network stack and relaying the PDU session to one or more RAN endpoints according to internal IP routing rules established for a PDU session over the control plane of a 5GS.

The GTP-U tunnel mechanism carries user data traffic over UDP transport over N3 and N9 interfaces. GTP-U tunnels between two corresponding GTP-U nodes separate traffic into different communication flows. A local Tunnel Endpoint Identifier (TEID), the IP address, and the UDP port uniquely identify a tunnel endpoint in each node, where the TEID assigned by the receiving entity is used for the communication. In an example of the 5GS CN GTP-U tunnels are established by providing the TEIDs and IP addresses between RAN and SMF. This is signaling over HTTP/2 between SMF and AMF and by Next Generation Application Protocol (NGAP) between AMF and RAN.

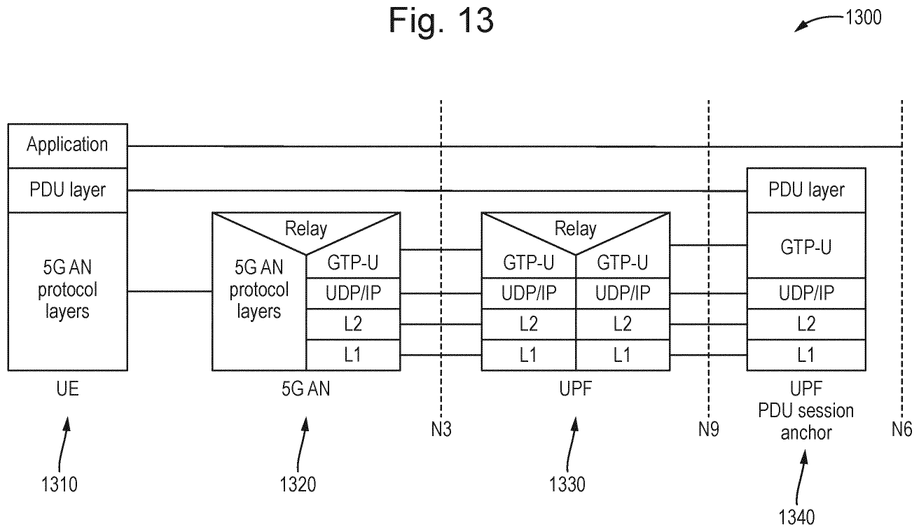

FIG. 13 illustrates a 5GS GTP-U data plane protocol stack of a PDU session 1300. The system comprises a UE 1310, a 5G AN 1320, a UPF 1330 and a UPF 1340. The UE 1310 may comprise a remote unit 102, a user equipment apparatus 200, a sender 900, or a UE 535, 1135 as described herein. The UPF 1340 may comprise a base unit 104, a network node 300, or a UPF 540, 1140 as described herein. The GTP-U header is a 4 byte-aligned structure formed in some embodiments of at least 8 bytes followed by at least 4 additional bytes depending on the content of the mandatory first 8 bytes. The GTP-U header can have in one embodiment one or more 4 byte-aligned extension headers which are chained together as a list by a prefixed next extension header type octet.

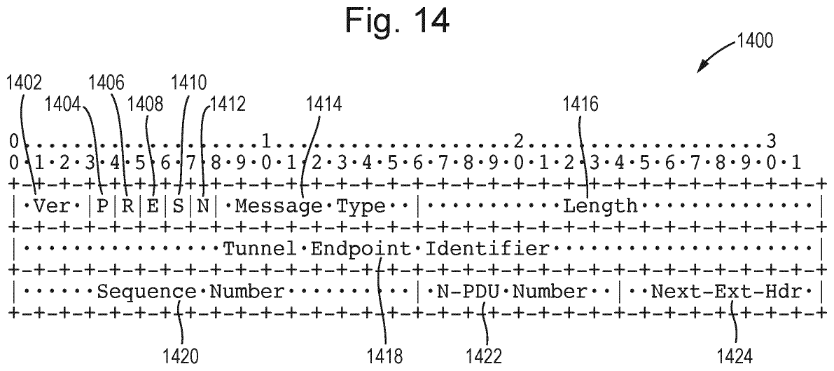

FIG. 14 illustrates the structure of the GTP-U header 1400. The GTP-U header comprises comprising: a version field (Ver) 1402 of 3 bits; a protocol type field (P) 1404 of 1 bit indicating a ‘1’ value for GTP-U; a reserved bit field (R) 1406 valued ‘0’; an extension header flag (E) 1408 bit field indicating the presence of an optional extension header field; a sequence number flag(S) 1410 bit field indicating the presence of an optional sequence number field; a N-PDU number flag (N) 1412 bit field indicating the presence of an optional N-PDU number field; a message type octet field 1414 indicating the type of GTP-U message (e.g., ‘255’ for G-PDU indicating a transport PDU); an octet field 1416 indicating the length of the payload in bytes; a 32 bits TEID 1418; an optional (increasing) sequence number octet field 1420 present if any of E, S, or N are toggled, yet to be processed only if S is toggled; an optional N-PDU number octet field 1422 present if any of E, S, or Nare toggled, yet to be processed only if N is toggled; and an optional next extension header type octet field 1424 present if any of E, S, or Nare toggled, yet to be processed only if E is toggled.

In some embodiments the information of the AL-FEC encoded PDU set is conveyed to/from the RAN by means of a GTP-U extension header. In an embodiment such an extension header includes information of at least one of:
an indication of the boundaries of a PDU set (e.g., a start and/or stop indication bit field, and/or a PDU set sequence number or identifier field),
an indication of the boundaries of a source PDU subset of the PDU set (e.g., a start and/or stop indication bit field corresponding to the source PDU subset)
an indication of the boundaries of a repair PDU subset of the PDU set (e.g., a start and/or stop indication bit field corresponding to the repair PDU subset)
an indication of the size of the PDU set size (e.g., as the number of all encoded PDUs forming the PDU set)
an indication of the size of the source PDUs subset of the PDU set (e.g., as the number of the source PDUs forming the source PDU subset)
an indication of the size of the repair PDUs subset of the PDU set (e.g., as the number of the repair PDUs forming the repair PDU subset)
an indication of the encoding rate of the AL-FEC configuration (e.g., as a bit field containing a tabulated index indicating a coding rate with a given granularity between a minimum coding rate, e.g., 0.25, and 1, i.e., uncoded, whereby the selected granularity occupies −log 2 (1/granularity) bits, or alternatively, a number of source PDUs and a number of total encoded PDUs within the PDU set)
an indication of a minimum number of PDUs (i.e., either source or repair PDUs) of the encoded PDU set that need to be successfully transmitted to a receiver for the receiver to be able to apply the AL-FEC coding configuration in decoding and recovering successfully the ADU encoded information.

In some embodiments the indication of the minimum number of necessary PDUs for ADU recovery is signaled as a percentage of the number of total PDUs in the encoded PDU set that need to be transmitted. In an example, the minimum number of necessary PDUs, i.e., m, for ADU recovery of an encoded PDU set is signaled as the quantized percentage value q′ that solves the problem:

$${q}^{′} = {argmin}_{q ∈ Q} ( q - \frac{m}{N} \geq 0 ) ,$$

where N denotes the number of total PDUs within the encoded PDU set and Q denotes the set of quantized percentage levels, e.g., Q={10, 20, 30, 40, 45, 50, 55, 60, 65, 70, 75, 80, 85, 90, 95, 100}. In this example any percentage level of Q is quantizable by 4 bits. The original m value signaled by q′ can be recovered thus by the reverse mapping:

$$m = ⌊ \frac{{q}^{′} \cdot N}{100} ⌋ .$$

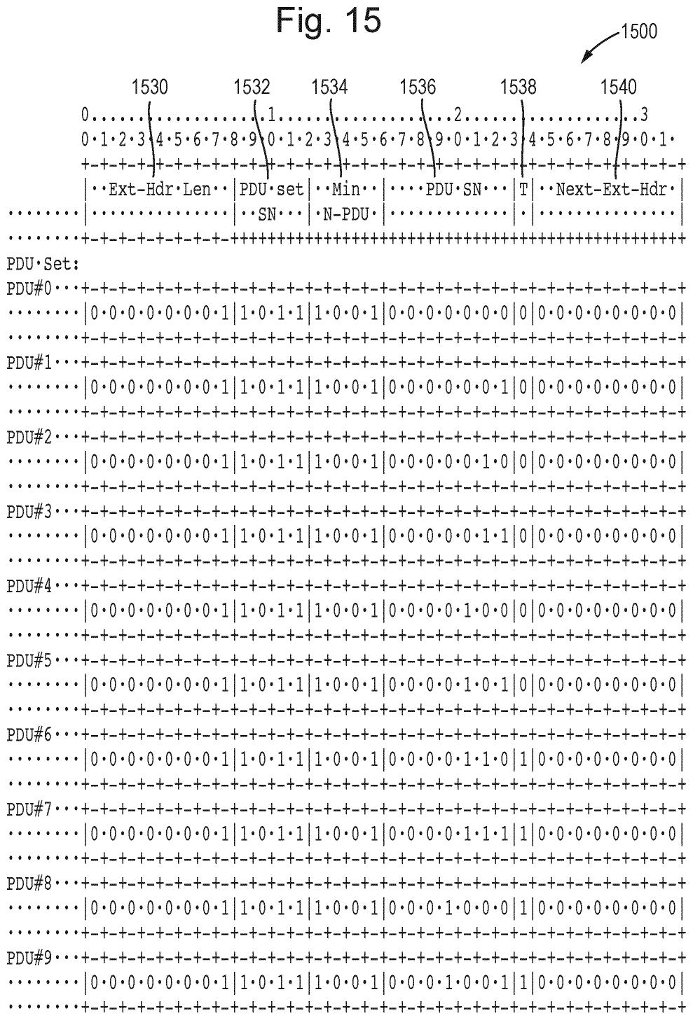

FIG. 15 presents an example of a minimal (i.e., least number of bytes possible) extension header 1500 of an AL-FEC encoded PDU set. The example extension header 1500 comprises: an octet (Ext Hdr Len, 1530) indicating the length of the extension header in units of 4 bytes; a nibble containing a PDU set sequence number (PDU set SN, 1532) increasing for each PDU set as a PDU set identifier module 2\hat{ }4; another nibble signaling the minimum number of necessary PDUs (Min N-PDU, 1534) for PDU set information recovery given the AL-FEC coding configuration and example signaling described above wherein q=10% is represented as ‘0000’ and q=100% is represented as ‘1111’ with the values in between represented monotonically increasing; a 7-bit field PDU sequence number (PDU SN, 1536) for each of the PDUs within the PDU set; a 1-bit field indicating the type (T, 1538) of each of the PDU, e.g., a ‘0’ value for a source PDU and ‘1’ value for a repair PDU; and a last byte (Next Ext Hdr, 1540) that signals that no other extension headers follow. In this case, the encoding rate of the AL-FEC of the PDU set is implicit given the PDU type marker and PDU SN within the PDU set, whereas the indication of the minimum number of necessary PDUs for the recovery of the encoded PDU set information is explicitly signaled. In the example of FIG. 15, a PDU set formed of 10 PDUs with 6 source PDUs and 4 repair PDUs is represented by means of the GTP-U extension headers of each PDU as previously described. The minimum number of necessary PDUs to recover the PDU set information with more than 99.99% certainty is thus m=7 given an AL-FEC coding configuration of a RaptorQ code with encoding-id=6 (i.e., corresponding to RaptorQ for single sequenced source RTP flows), T=1280 bytes encoding symbols, and a source block of maximum length of K_max=50 symbols. This maps to q′=70, represented as ‘1001’ as a nibble.

In some embodiments, the AL-FEC coding configuration information associated with a plurality of PDU sets is signaled over a control plane mechanism for downstream processing, e.g., by one or more RAN endpoints. In one embodiment, the AL-FEC coding configuration information contains, in part: an encoding scheme; an encoding rate; and/or a minimum percentage of PDUs (i.e., either source of repair PDUs) out of the encoded PDU set necessary to guarantee recovery of the ADU information given a set of QoS rules.

The AL-FEC coding configuration information is indicated by the SMF to the RAN over the AMF N2 interface. In another embodiment, the same information is signaled to the UE by the SMF over the AMF N1 interface for AL-FEC encoded PDU set traffic pertaining to UL. In an example, an application indicates via its AF the NEF and PCF with a corresponding set of PFD traffic descriptors and QoS requirements associated with an AL-FEC configuration used to encode application ADUs to PDU sets. The PCF generates PCC rules and configures the SMF with a corresponding set of QoS rules including an indication of a minimum percentage of PDUs (i.e., either source or repair PDUs) out of an encoded PDU set corresponding to the AL-FEC configuration that require transmission given the QoS requirements of the application.

Consider one example of an application with QoS requirements of an ADU error rate/PSER of 1e-2 that uses an AL-FEC RaptorQ systematic coding scheme (e.g., encoding-scheme-id=6 according to IETF RFC 6681) to encode ADUs to PDU sets with a configured redundancy level

$$R \% {=}^{def} ( N - K ) / K$$

for any A source PDUs of a source block. This requires at least K+1 PDUs to recover the ADU information with at least 99.99% corresponding to the QoS requirements, and as such, a defined QoS rule indicating that a percentage of at least:

$$\frac{K + 1}{N} = \frac{1}{1 + \frac{R \%}{100}} + \frac{1}{N}$$

PDUs out of any N PDUs of an encoded PDU set satisfies the PSER QoS requirements of the application.

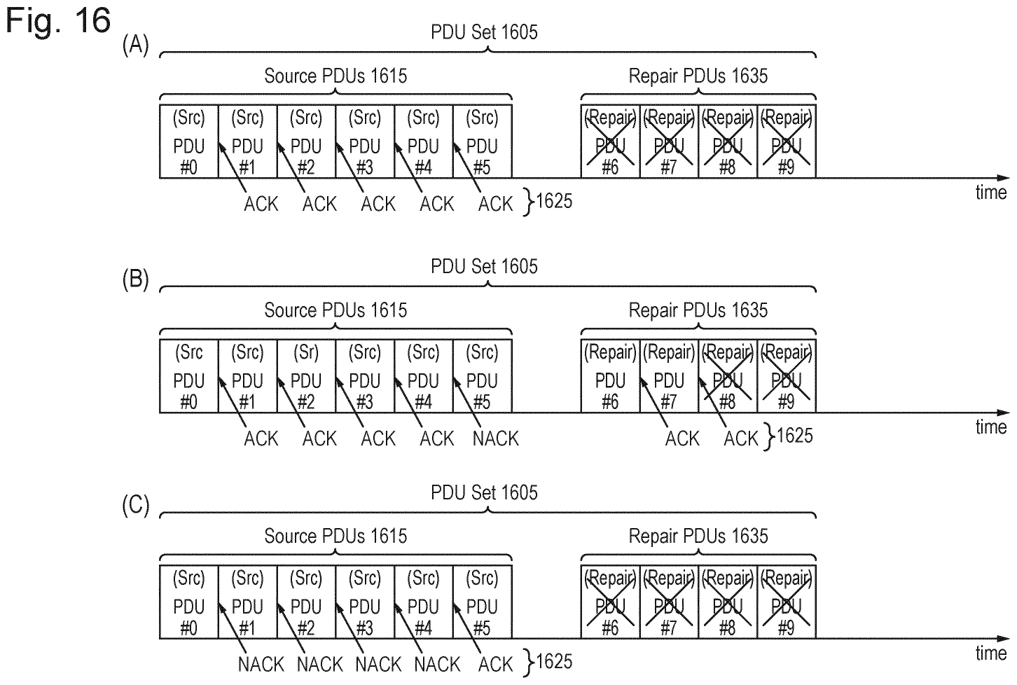

FIG. 16 illustrates RAN dropping of PDUs of an AL-FEC encoded PDU set. Three examples are illustrated, (A), (B) and (C). In each example, a PDU set 1605 comprises a plurality of source PDUs 1615 and a plurality of repair PDUs 1635. Acknowledgements (ACKs) or negative-acknowledgements (NACKs) are transmitted in respect of some of the PDUs. The determination of the AL-FEC encoded PDU sets, associated signaling of AL-FEC awareness and PDU sets metadata enable optimizations of downstream processing. In an embodiment, the latter information is processed by a RAN node for the purpose of one or more PDUs dropping out of a PDU set. The RAN node applies the dropping technique to optimize radio resource allocation by impeding over-provisioning of resources for PDUs that are either redundant (i.e., information available at a receiver suffices to recover ADU information given AL-FEC encoding, (A)) or obsolete (i.e., information that can still be transmitted does not suffice to recover ADU information given AL-FEC encoding, (C)).

In one embodiment, the RAN node is indicated with the AL-FEC configuration either by means of control plane signaling or by means of data plane signaling. In one example, the control plane signaling comprises of the AMF N2 interface being used to relay to the RAN the SMF determined PFD rules and QoS rules associated with an AL-FEC coding configuration applied for the associated traffic of the application PDU sets. In such a case, the AF indicates to the NEF/PFDF API the PFD set associated with specific AL-FEC configurations which are subsequently managed by the PFD management procedure via the SMF. In addition, the AF indicates to the PCF the QoS requirements associated with the AL-FEC encoded traffic, and the PCF configures with subsequent QoS rules the SMF. This control-plane signaling path is indicated in FIG. 11 as a dashed line for the PFD rules and a solid line for the QoS rules.

In another example, the data plane is leveraged whereby the PDU sets enclosed metadata is comprised within GTP-U extension headers carrying information about the AL-FEC. This implicit data plane signaling is thus used by the RAN to acquire the AL-FEC coding configuration information, and, at the same time, determine the PDU sets boundaries. As a result, the RAN becomes aware of both AL-FEC and the AL-FEC encoded PDU sets, and in some embodiments the RAN is signaled with at least one of a control-plane signaling procedure or a data-plane signaling procedure

As AL-FEC coding acts as a packet erasure code, many of its applicable coding schemes (e.g., Raptor/RaptorQ codes, MDS codes, Reed-Solomon codes, 1D/2D flexible parity check codes etc.) provide analytic bounds of performance regarding information recovery given a certain number of encoding symbols and/or packets are lost out of a codeword, or equivalently an encoded source block.

For instance, Reed-Solomon codes are known to correct up to t=n-k encoding symbols erasures for a code of length n symbols containing k information symbols, whereby the positions of the t erasures are known. This bound is in practice achievable whereby sequence numbering is usually used to locate the prospective erasures of encoding symbols. Another example is the case of RaptorQ codes over GF (2⁸) (e.g., cf. IETF RFC 6330), whereby the code is guaranteed to recover the original information of a source block of K encoding symbols based on any K+h encoding symbols (i.e., either source symbols or repair symbols) with an approximate probability of

$$1 - \frac{1}{{2}^{8 * ( h + 1 )}} .$$

Therefore, out of a total of N RaptorQ GF (2⁸)-encoded symbols, K+1 symbols are sufficient on average to recover the original source block information with a probability higher than 99.99%.

In some embodiments, the AL-FEC configuration parameters, such as the AL-FEC coding scheme, (e.g., Raptor/RaptorQ, Reed-Solomon), AL-FEC coding rate, (e.g., the number of totally encoded symbols/PDUs, the number of source symbols/PDUs and/or the number of repair symbols/PDUs for a source block size), are used together with the QoS flow requirements (e.g., packet error rate (PER) and/or PDU set error rate (PSER)) of a PDU set flow to determine a minimum number of PDUs out of the encoded PDU set that are necessary to be transmitted correctly. The minimum number of PDUs are necessary given the AL-FEC for the encoded PDU set ADU information to be recovered at the receiver application side with a certain high probability of recovery. In some examples this probability of recovery is set to match or exceed the reciprocal value of the PER or PSER requirements associated to the QoS flow of the PDU set. The successful recovery at the receiver indicates a PDU set transmission success from an information-theoretic standpoint despite some of the PDUs belonging to the PDU set not being received.

In addition, in many embodiments, the AL-FEC used are systematic codes such that the encoding output generates identical source encoded PDUs to the source PDUs inputs to the code. This guarantees exact recovery given for example that the source PDUs are all received correctly, yet none of the repair PDUs are not.

A RAN indicated in part with the AL-FEC configuration, encoded PDU sets and their subsets of source PDUs and repair PDUs, and the threshold of minimum necessary PDUs to be received successfully for ADU information recovery is therefore capable to determine policies to drop PDUs of the encoded PDU sets for optimization of radio resource allocation and further system capacity increase. In some embodiments, consider a RAN that receives AL-FEC encoded PDU sets (e.g., UDP/IP enclosed RTP packets tunneled via GTP-U) by a RaptorQ code in Single Sequenced Flow encoding mode according to RFC 6681 with an encoding symbol size of T=1420 bytes and a maximum source block length Kₘₐₓ=50.

In one example, the RAN is further signalled that the QoS flow associated with the PDU set require a PER of 1e-2 and/or a PSER of 1e-2 with a PDB of 10 ms. In such a case, the RAN is signalled by higher layers or determines based on these parameters that for a PDU set comprising of 10 PDUs out of which 6 correspond to source PDUs and 4 correspond to repair PDUs (i.e., a coding rate of 0.6 or alternatively a redundancy level of 66.67%), any 7 encoded PDUs that are transmitted successfully fulfil the PER/PSER requirements. In this case 7 is the threshold of minimum necessary PDUs (i.e., any PDUs either source or repair) that need to be transmitted to fulfil the QoS requirements of the associated flow. On the other hand, given the systematic coding scheme used, the RAN is also capable of determining that if the 6 source PDUs are transmitted successfully, the repair PDUs are not needed at the receiver and can be dropped. As used herein 1e-2 means 10⁻².

The following embodiments outline thus three example policies describing the dropping behaviour of the RAN given the AL-FEC encoded PDU sets. Consider for the sequel the context set by the previous example determination of 7 as the threshold of minimum necessary PDUs for the AL-FEC encoding configuration of a RaptorQ (Kₘₐₓ=50, T=1420) systematic code, and an encoded PDU set of 10 PDUs comprised of a first subset of 6 source PDUs and a second subset of 4 repair PDUs.

In one embodiment, the RAN decides to drop the repair PDUs of an AL-FEC encoded PDU set 1605 if all the source PDUs 1615 of the encoded PDU set have been successfully transmitted to a UE. The successful transmissions of the source PDUs 1615 are to this end indicated by the UE by means of feedback acknowledgements, either by HARQ at L1 or by ARQ at L2 (e.g., by RLC status reports). This is illustrated in FIG. 16 (A) for the considered example. As the 6 source PDUs are ACKed 1625 by the time the 4 repair PDUs 1635 are ingested by the RAN and/or scheduled, e.g., given the repair-window of the AL-FEC encoding, the 4 repair PDUs can be dropped without any loss of information at the ADU level for the application.

In some embodiments, the RAN threshold of minimum necessary PDUs (as either source PDUs 1615 or repair PDUs 1635) for recovery of a full ADU information is used to determine the number of PDUs to be dropped given that a subset of PDUs has already been transmitted to a UE. In such embodiments, the RAN threshold of minimum necessary PDUs is determined either by means of RAN being signaled by the upper layers the threshold of the minimum necessary PDUs as a bitfield representation or by means of RAN-side determination given the AL-FEC coding configuration and PDU set metadata information for a QoS flow. The transmissions statuses of the already transmitted PDUs are to this end indicated by the UE by means of feedback acknowledgements/non-acknowledgements 1625, either by HARQ at L1 or by ARQ at L2 (e.g., by RLC status reports).

In one embodiment, the RAN decides to drop a remaining subset of PDUs (either source or repair PDUs) out of the encoded PDU set if a previous subset of at least the threshold of minimum necessary PDUs has been already successfully transmitted. In the example of FIG. 16 (B) the #0, #1, #2, #3, #4 source PDUs 1615 are ACKed, whereas #5 is NACKed and its PDB expired. As a consequence, the RAN schedules #6 and #7 PDUs (i.e., repair PDUs 1635) which are subsequently ACKed and it drops the processing of further repair PDUs as 7 PDUs are successfully transmitted to the UE matching the threshold of minimum necessary PDUs to recover the ADU information with more than a 99.99% probability on average and fulfilling thus the QoS requirements of 1e-2 PSER.

In a second embodiment, the RAN decides to drop any remaining subset of PDUs (either source or repair PDUs) out of the encoded PDU set if a previous subset greater than the total number of PDUs in the PDU set minus the threshold of minimum necessary PDUs has been already unsuccessfully transmitted (i.e., the PDUs have been NACKed and the PDUs PDB has expired). In the example of FIG. 16 (C) the #0, #1, #2, #3, #4 source PDUs are NACKed whereas #5 is ACKed. Yet, the remaining 4 repair PDUs 1635 cannot successfully recover the ADU information even if successfully transmitted given the determined threshold of minimum necessary PDUs of 7 corresponding to the required QoS PSER and the AL-FEC coding scheme applied. As such, the 4 repair PDUs are also dropped by the RAN in this example.

In an embodiment, the same dropping procedure and policies applied to the RAN are performed at a UE performing UL transmissions of AL-FEC encoded PDU sets for an application. In this embodiment, the UE performs packet filtering to determine PDU sets and acquire necessary AL-FEC awareness, and is indicated by the application a minimum threshold of necessary PDUs of the encoded PDU sets to be successfully transmitted for ADU information recovery, or determines such a minimum threshold of necessary PDUs given its awareness of the AL-FEC coding configuration and PDU sets.

In some embodiments, the RAN and/or UE dropping of PDUs of a PDU set corresponds to stopping Layer 2/Layer 1 processing of transmission operations for the dropped PDUs. Concretely, in some examples this implies at least one of:
stopping buffering incoming PDUs of the PDU set;
stopping scheduling radio resources, e.g., time slots, frequency carriers and/or spatial layers, and/or stopping configuring grants for one or more PDUs of the PDU set;
stopping packetizing one or more PDUs of the encoded PDU set for radio transmission e.g., PDCP processing, RLC processing, TB encapsulation and logic channels multiplexing;
stopping processing feedback procedures of automatic repeat request/hybrid automatic repeat request acknowledgements;
stopping processing physical layer forward error correction encoding, layer mapping, modulation and physical channel over-the-air transmission procedures;
signaling Buffer Status Reports (BSRs) (e.g., by a UE in UL) indicating the dropping of subsequent and updating the buffer status; and
entering a lower power saving mode (e.g., at the UE) or selecting a more efficient Discontinuous Reception (DRX) configuration (e.g., the UE selects a more efficient DRX configuration given a RAN signaled set of available DRX configurations).

In one embodiment, the RAN may further signal to a UE the dropping of a subset of PDUs belonging to a PDU set by an indication marker informing the UE that no further receiving of the subset of PDUs of the PDU set is to be expected. The UE is thus informed and consequently may synchronize its PDU set receive operations to the gNB, perform AL-FEC decoding of the transferred PDUs of the encoded PDU set, and perform any UE specific optimizations. Such UE specific optimizations may comprise: entering a lower power state, flushing receive buffer states, releasing HARQ processes, etc., Similarly, in another embodiment, the UE may indicate to the RAN ceasing UL transmissions for a PDU set. Upon the received indication, the RAN will perform the same operations for AL-FEC decoding of the uplinked ADU information and for RAN radio transmit-receive optimizations.

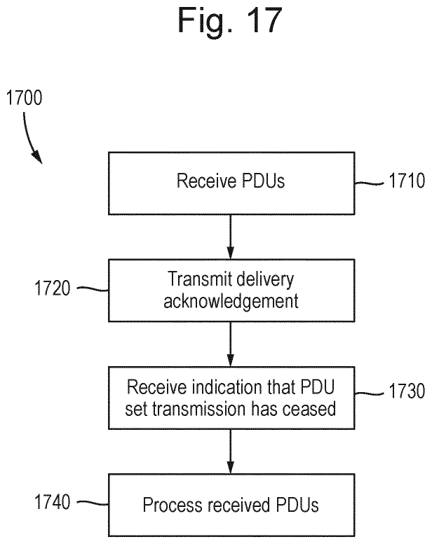

FIG. 17 illustrates a method 1700 in a user equipment apparatus of a wireless communication network. The method 1700 comprises receiving 1710 a subset of protocol data units (PDUs) of a PDU set, the PDU set corresponding to an encoded application data unit (ADU) and an Application-Level Forward Error Correction (AL-FEC) coding configuration, whereby the encoding of the encoded ADU is based on the AL-FEC coding configuration. The method 1700 further comprises transmitting 1720 delivery acknowledgements in response to the received PDUs, and receiving 1730 an indication that no further PDUs belonging to the PDU set will be transmitted. The method 1700 further still comprises processing 1740 the decoding of the encoded ADU based on the received AL-FEC coding configuration and on the received subset of PDUs.

The delivery acknowledgements may comprise a hybrid automatic repeat request acknowledgement or an automatic repeat request acknowledgement. The nature of a delivery acknowledgement may comprise delivery acknowledged, or delivery not acknowledged. The indication that no further PDUs belonging to the PDU set will be transmitted may comprise a cease indication. The indication that no further PDUs belonging to the PDU set will be transmitted may be based on the transmitted delivery acknowledgements and a cease criterion determined by a transmitting node that transmits the PDUs. After the cease indication is received, the received PDUs with a delivery acknowledged out of the PDU set may be used to decode the encoded ADU information given the AL-FEC coding configuration used for encoding by the transmitter. In one embodiment the successfully received information is sufficient to recover the ADU. In another embodiment the successfully received information is not sufficient to recover the ADU.

The user equipment is arranged to receive transmissions from the wireless communication network. The transmissions may be transmitted by a base station. The transmissions may be transmitted by a transmitter of a base station.

There is further provided a user equipment apparatus for communicating with a wireless communication network, the user equipment apparatus comprising a receiver a transmitter and a processor. The receiver is arranged to receive a subset of protocol data units (PDUs) of a PDU set, the PDU set corresponding to an encoded application data unit (ADU) and an Application-Level Forward Error Correction (AL-FEC) coding configuration, whereby the encoding of the encoded ADU is based on the AL-FEC coding configuration. The transmitter is arranged to transmit delivery acknowledgements in response to the received PDUs. The receiver is further arranged to receive an indication that no further PDUs belonging to the PDU set will be transmitted. The processor is arranged to decode the encoded ADU based on the received AL-FEC coding configuration and on the received subset of PDUs.

There is disclosed herein a method for triggering RAN-level dropping of PDUs of an AL-FEC encoded PDU set based on AL-FEC and PDU set awareness. Three examples or general policies for dropping PDUs of AL-FEC encoded PDU sets for the proposed method applicable to unnecessary PDUs are presented. Unnecessary PDUs may be dropped out of AL-FEC encoded PDU sets. For example, the receiver may have received already enough packets to decode the desired ADU information so any other PDUs are redundant. Alternatively, the receiver may be unable to recover anymore the desired ADU information encoded by the PDU set as too many PDU erasures (or transmission losses) have already happened.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards and application types, these examples are not intended to be the limit of the communications standards or application types to which the disclosed method and apparatus may be applied. For example, while specific examples have been given in the context of 3GPP, the principles disclosed herein can also be applied to another wireless communications system, and indeed any communications system which uses routing rules. Indeed, the methods and apparatus described herein are not only applicable to NR applications but can be used for any AL-FEC encoded application served over RTP or alike and that use PDU sets.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document: 3GPP, 3rd generation partnership project; 5G, fifth generation; 5GS, 5G System; 5QI, 5G QoS Identifier; ADU, application data unit; AF, application function; AMF, access and mobility function; AR, augmented reality; ARQ, automatic repeat request; DL, downlink; FEC, forward error correction; AL-FEC, application-layer forward error correction; FECFRAME, forward error correction framework; HARQ, hybrid automatic repeat request; NAL, network abstraction layer; NEF, network exposure function; PCF, policy control function; PDU, protocol data unit; PFD, packet flow description; PFDF, packet flow description function; PPS, picture parameter set; QoE, quality of experience; QoS, quality of service; RAN, radio access network; RTCP, real-time control protocol; RTP, real-time protocol; SDAP, service data adaptation protocol; SMF, session management function; SRTCP, secure real-time control protocol; SRTP, secure real-time protocol; UE, user equipment; UL, uplink; UPF, user plane function; VCL, video coding layer; VMAF, video multi-method assessment function; VPS, video parameter set; VR, virtual reality; XR, extended reality; XR AS, XR application server; and XRM, XR media.

1. A method performed by a node of a wireless communication network, the method comprising:
receiving from an application a protocol data unit (PDU) set corresponding to an encoded application data unit (ADU);
determining an Application-Layer Forward Error Correction (AL-FEC) coding configuration associated with the encoded ADU;
transmitting the PDU set;
determining whether a cease criterion is satisfied, wherein the cease criterion is based on the AL-FEC coding configuration; and
ceasing transmission of the PDU set based on the cease criterion being satisfied.

2. The method of claim 1, wherein the received PDU set comprises a plurality of source PDUs and a plurality of repair PDUs, and wherein the plurality of repair PDUs are associated with the plurality of source PDUs based on an encoding with the AL-FEC coding configuration.

3. The method of claim 2, wherein the cease criterion comprises a threshold of minimum necessary PDUs of the PDU set required to recover the encoded ADU.

4. The method of claim 3, further comprising determining the threshold of minimum necessary PDUs based at least in part on the AL-FEC coding configuration, wherein the AL-FEC coding configuration further comprises one or more of:
an encoding rate indication;
an indication of the plurality of source PDUs and an indication of the plurality of repair PDUs; and
an explicit indication of a minimum number of PDUs within the PDU set for recovery of the encoded ADU;
an associated quality of service (QoS) flow requirement of a PDU error rate; or
an associated QoS flow requirement of a PDU set error rate.

5. The method of claim 3, wherein the cease criterion comprises a successful transmission of a number of PDUs of the PDU set, and wherein the number of PDUs is greater than or equal to the threshold of minimum necessary PDUs.

6. The method of claim 3, wherein the cease criterion comprises an unsuccessful transmission of a number of PDUs of the PDU set, and wherein the number of PDUs is greater than or equal to a total number of PDUs in the PDU set minus the threshold of minimum necessary PDUs.

7. The method of claim 2, wherein the cease criterion comprises a successful transmission of the plurality of source PDUs.

8. The method of claim 1, further comprising receiving one or more delivery acknowledgements, wherein a determination that the cease criterion is satisfied is based at least in part on the one or more delivery acknowledgements.

9. A node in a wireless communications network, the node comprising:
a memory; and
a processor coupled with the memory and configured to cause the node to:
receive, from an application, a protocol data unit (PDU) set corresponding to an encoded application data unit (ADU);
determine an Application-Layer Forward Error Correction (AL-FEC) coding configuration associated with the encoded ADU;
transmit the PDU set;
determine whether a cease criterion is satisfied, wherein the cease criterion is based on the AL-FEC coding configuration; and
cease transmission of the PDU set based on the cease criterion being satisfied.

10. The node of claim 9, wherein the received PDU set comprises a plurality of source PDUs and a plurality of repair PDUs, and wherein the plurality of repair PDUs are associated with the plurality of source PDUs based on an encoding with the AL-FEC coding configuration.

11. The node of claim 10, wherein the cease criterion comprises a threshold of minimum necessary PDUs of the PDU set required to recover the encoded ADU.

12. The node of claim 11, wherein the processor is configured to cause the node to determine the threshold of minimum necessary PDUs based at least in part on the AL-FEC coding configuration, and wherein the AL-FEC coding configuration further comprises one or more of:
an encoding rate indication;
an indication of the plurality of source PDUs and an indication of the plurality of repair PDUs;
an explicit indication of a minimum number of PDUs within the PDU set for recovery of the encoded ADU;
an associated quality of service (QoS) flow requirement of a PDU error rate; or
an associated QoS flow requirement of a PDU set error rate.

13. The node of claim 11, wherein the cease criterion comprises a successful transmission of a number of PDUs of the PDU set, and wherein the number of PDUs is greater than or equal to the threshold of minimum necessary PDUs.

14. The node of claim 11, wherein the cease criterion comprises an unsuccessful transmission of a number of PDUs of the PDU set, and wherein the number of PDUs is greater than or equal to a total number of PDUs in the PDU set minus the threshold of minimum necessary PDUs.

15. The node of claim 10, wherein the cease criterion comprises a successful transmission of the plurality of source PDUs.

16. The node of claim 9, wherein the processor is configured to cause the node to receive one or more delivery acknowledgements, and wherein a determination that the cease criterion is satisfied is based at least in part on the one or more delivery acknowledgements.

17. A method performed by a user equipment of a wireless communication network, the method comprising:
receiving a subset of protocol data units (PDUs) of a PDU set, the PDU set corresponding to an encoded application data unit (ADU) and an Application-Level Forward Error Correction (AL-FEC) coding configuration, wherein an encoding of the encoded ADU is based on the AL-FEC coding configuration;
transmitting one or more delivery acknowledgements in response to the received subset of PDUs;
receiving an indication that no further PDUs belonging to the PDU set are to be transmitted; and
decoding the encoded ADU based on the received AL-FEC coding configuration and on the received subset of PDUs.

18. A user equipment (UE) for wireless communication, comprising:
a memory; and
a processor coupled with the memory and configured to cause the UE to:
receive a subset of protocol data units (PDUs) of a PDU set, the PDU set corresponding to an encoded application data unit (ADU) and an Application-Level Forward Error Correction (AL-FEC) coding configuration, wherein an encoding of the encoded ADU is based on the AL-FEC coding configuration;
transmit one or more delivery acknowledgements in response to the received subset of PDUs;
receive an indication that no further PDUs belonging to the PDU set are to be transmitted; and
decode the encoded ADU based on the received AL-FEC coding configuration and on the received subset of PDUs.

19. The method of claim 1, wherein the node comprises a user plane function (UPF), and wherein transmitting the PDU set comprises transmitting one or more downlink packets.

20. The method of claim 1, wherein the node comprises a user equipment (UE), and wherein transmitting the PDU set comprises transmitting one or more uplink packets.
